(19) United States
(12) Patent Application Publication
(10) Pub. No.: US 2026/0339636 A1
(43) Pub. Date: Oct. 29, 2026

(54) Universal Loop-Multiplier Injector for Compiled Physics Software

(71) Applicant: Jonathan Washburn, Austin, TX (US)

(72) Inventor: Jonathan Washburn, Austin, TX (US)

(21) Appl. No.: 19/652,681

(22) Filed: Apr. 20, 2026

Related U.S. Application Data
(60) Provisional application No. 63/794,430, filed on Apr. 25, 2025.

(51) Int. Cl. G06F 8/41; G06F 8/70

(52) U.S. Cl. CPC G06F 8/49; G06F 8/70

(57) ABSTRACT

Methods, systems, and computer-readable media are disclosed for dynamically modifying machine-encoded numerical values in compiled physics software without source-code modification or recompilation. A target executable process is identified, executable memory pages are enumerated, and selected pages are copied into a scratch buffer. Candidate locations are detected by scanning aligned 8-byte chunks interpreted as IEEE-754 double-precision values and comparing them with machine-encoded reference patterns for selected physical constants or integer powers thereof. Replacement values are computed according to a selected correction scheme, encoded into machine-encoded replacement patterns, confirmed to fall within an allowed module scope under an active policy before writing, and written under controlled permission conditions with postwrite verification. Original bytes and replacement bytes are recorded to support rollback, and authenticated patch payloads may be verified before patching.

### CROSS-REFERENCE TO RELATED APPLICATIONS

This application is related to U.S. non-provisional patent application No. 63/794,430, filed on Apr. 25, 2025. The disclosure of that application is incorporated herein by reference to the extent permitted by law and to the extent not inconsistent with the present disclosure.

### BACKGROUND OF THE INVENTION

The present disclosure relates generally to dynamic binary instrumentation, runtime code modification, executable-memory management, and scientific-computing middleware, and more particularly relates to methods and systems for detecting machine-encoded numerical constants within compiled physics software and replacing those numerical constants during execution with corrected numerical values without requiring source-code modification or recompilation.

A persistent technical problem in scientific and engineering computing is that many production-grade simulation environments, numerical solvers, analysis pipelines, and validated computational models are distributed and operated as compiled executables in which physically meaningful constants are embedded as machine-representable numeric values rather than being externalized into editable configuration layers. In practical deployments, such constants may appear not only as direct encodings of a base value, but also as precomputed powers, normalized coefficients, unit-converted values, folded expressions, lookup-table entries, compiler-materialized immediate operands, shared-library literals, or repeated binary instances distributed across multiple executable pages. As a result, even when an improved or replacement constant value becomes available, updating the deployed software stack is often technically difficult, operationally disruptive, or effectively impossible.

Existing source-level revision techniques do not adequately solve this problem. In many environments, the operator of a target executable lacks access to the source code, lacks the build chain needed to regenerate the executable, or lacks permission to alter a validated codebase.

Even where source access exists, a target constant may be represented under inconsistent names, duplicated across modules, inlined by a compiler, pre-expanded into derived forms, or embedded in third-party dependencies such that identifying every occurrence is labor-intensive and error-prone. Recompilation itself may trigger extensive regression obligations, qualification procedures, recertification burdens, cluster redeployment costs, and reproducibility concerns, particularly in regulated, safety-critical, scientific, defense, aerospace, pharmaceutical, and high-performance computing environments. In long-lived simulation infrastructures, a seemingly simple constant update can therefore become blocked not by the mathematical availability of a corrected value, but by the engineering friction associated with modifying and rebuilding the software that consumes that value.

The problem is more acute in compiled physics software because the numerical effect of a constant is often propagated far beyond a single symbolic definition. A fine-structure constant, gravitational constant, coupling term, weak mixing parameter, mass term, Boltzmann term, or speed-of-light term may influence initialization routines, kernel coefficients, cross-section calculations, energy updates, state transitions, matrix assembly, convergence criteria, stochastic sampling behavior, solver stability, or output post-processing. A constant may also appear in multiple powers, such as first-order, squared, cubed, or higher-order forms, because the original executable may have been optimized to avoid repeated runtime exponentiation. In such cases, changing only one source-level declaration, even if possible, may not reliably propagate to all materialized binary instances that affect runtime behavior. A practical update mechanism therefore must address direct and derived encodings as they actually exist inside executable memory, rather than assuming that the binary preserves a neat one-to-one relationship with source-code declarations.

Conventional runtime instrumentation frameworks also fail to solve this specific technical problem. Existing tools for profiling, tracing, hooking, or dynamic analysis typically operate at the level of function interception, basic-block instrumentation, API wrapping, or control-flow observation. Those tools are generally designed to monitor execution or redirect calls, not to identify a class of machine-encoded floating-point values corresponding to selected physical constants and their powers, compute corrected substitutes, and overwrite the selected binary locations in a way that preserves executable continuity and system protections. A function-hooking approach is frequently insufficient because the numerical constant may be loaded from static executable data or materialized as an immediate value without passing through a callable interface that can be intercepted. Likewise, a generic memory editor is not an adequate substitute because it lacks application-aware target selection, floating-point tolerance logic, constant-class handling, reproducible replacement generation, authenticated payload control, and rollback integrity needed for safe scientific use.

A further technical shortcoming of prior approaches is that executable-memory modification must coexist with modern process-protection mechanisms. Production operating systems commonly enforce address space layout randomization, data execution prevention, page-permission isolation, write-versus-execute restrictions, integrity controls, and thread concurrency rules that complicate in-place binary patching. Naive runtime replacement can destabilize a process by patching an active page while other threads are executing, by leaving a page in an over-permissive state, by introducing partial writes, by failing to maintain cache coherency, or by breaking reproducibility and rollback. In high-value computing environments, a deployment mechanism that changes constant values but cannot demonstrate deterministic targeting, controlled overwrite procedures, restoration capability, and auditability is often not acceptable for production use. Accordingly, there is a need for a patching architecture that does more than merely write different bytes into memory. There is a need for a controlled instrumentation architecture that can identify executable pages, scan for target values, manage overwrite conditions, preserve or restore security attributes, coordinate thread state, maintain integrity records, and support reliable reversal of each applied patch.

The technical problem also extends to provenance, trust, and configuration control. If a runtime system modifies fundamental numerical values used by a scientific executable, operators need to know which values were changed, where those values were changed, which correction policy generated the replacements, whether the replacement payload was authorized, whether the same patch set can be reproduced in later runs, and whether the process can be returned exactly to its original state. Prior approaches typically do not provide a unified framework in which constant selection, replacement computation, payload authentication, overwrite execution, rollback data, and audit reporting are integrated into a single machine-operable system. This deficiency matters because scientific reproducibility, regulatory review, engineering validation, and comparative testing often depend on being able to prove not just that a program ran, but which numeric assumptions were active when it ran.

The present technology arose in part from the recognition that a useful constant-update mechanism must operate on compiled binaries as deployed artifacts rather than on source code as an abstract upstream representation. It was further recognized that the mechanism must be capable of handling target values that are encoded as IEEE-754 double-precision values within executable memory pages, including both direct constants and selected powers of those constants, because those encodings are a common machine-level form in scientific executables. It was also recognized that, in many use cases, a corrected value should be propagated multiplicatively across all detected instances of a selected constant class so that the numerical replacement remains internally coherent across multiple compiled occurrences of related values.

In preferred embodiments described herein, the correction framework is especially useful for propagating Recognition-Physics loop corrections into compiled physics software. In that preferred context, a loop correction parameter is derived from an optimal recognition scale and a loop correction ratio, and a corrected constant is generated by multiplying a base constant by a factor based on one minus the loop correction parameter. The runtime instrumentation problem, however, is not limited to theoretical derivation alone. The practical engineering challenge is how to propagate such corrected values into already-compiled executables in a deterministic, secure, reversible, and auditable manner, including executables that are closed-source, containerized, prevalidated, library-linked, or deployed across cluster infrastructure. Prior systems do not provide an adequate end-to-end mechanism for accomplishing that task at the binary level.

What is needed, therefore, is a technical solution that can attach to or load into a target executable environment, enumerate executable memory regions, detect machine-encoded occurrences of selected constants and constant-power instances, compute corrected replacements according to a selected correction scheme, overwrite those occurrences under controlled memory-protection conditions, preserve execution viability, maintain rollback capability, and generate a trustworthy audit trail. What is further needed is such a solution in a form that can be deployed across heterogeneous operating systems, support compiled scientific workloads without requiring recompilation, and enable side-by-side evaluation of original and corrected constant regimes in real-world computational environments.

### SUMMARY OF THE INVENTION

The present disclosure provides methods, systems, and computer-readable media for dynamically propagating corrected numerical values into compiled physics software by detecting machine-encoded target values within executable memory and replacing those target values during execution without requiring source-code modification or recompilation. In disclosed embodiments, an injector architecture interacts with a target executable process, identifies executable memory pages that are candidates for scanning, evaluates machine-encoded numeric content within those pages against a target-value library, determines whether detected content corresponds to one or more selected constants or constant-power instances, computes replacement values according to a selected correction scheme, and patches the detected locations in a controlled manner that preserves process operability and supports reproducible rollback and audit behavior.

In one aspect, the disclosure provides a dynamic binary instrumentation architecture configured to operate on compiled executables as deployed artifacts rather than relying on source-level edits. The architecture can therefore be used with open-source executables, closed-source executables, shared-library-based scientific programs, prevalidated production binaries, containerized workloads, cluster-deployed applications, and other runtime environments in which direct source modification, rebuild operations, or broad software requalification would be impractical, unavailable, undesirable, or operationally disruptive. By operating directly on executable memory representations of target values, the disclosed architecture addresses the technical mismatch between how constants are conceptually specified in source code and how those constants are actually materialized in an optimized compiled executable.

In another aspect, the disclosure provides a target-value detection framework in which a target-value library defines one or more numeric values to be detected within executable memory. The target values can include direct constants, powers of direct constants, derived numerical expressions, context-specific numerical parameters used by compiled physics software, or combinations thereof, provided that such values are represented in a machine-detectable format in the target executable environment. In preferred embodiments, the detection framework generates reference encodings for selected constants and integer powers thereof and compares those reference encodings with aligned machine-readable chunks of executable-page content. In more particular embodiments, the machine-readable chunks are interpreted as IEEE-754 double-precision values and are evaluated using an objective tolerance rule, such as a plus-or-minus one-unit-in-the-last-place comparison rule, to identify patch candidates with low false-positive probability while retaining practical sensitivity to compiled numeric representations.

In another aspect, the disclosure provides a correction engine that computes replacement values for detected target-value instances. The correction engine can operate under a selected correction scheme and can therefore support a preferred correction model together with optional baseline, comparative, or user-specified schemes. In preferred embodiments, the selected correction scheme is a Recognition-Physics correction scheme in which an optimal recognition scale and a loop correction ratio are used to derive a loop correction parameter, and a corrected constant is generated by multiplying a base constant by a factor based on one minus the loop correction parameter. A replacement value for a detected power instance can then be computed as the corrected constant raised to the detected power, thereby preserving the intended multiplicative relation across first-order and higher-order compiled occurrences. This architecture produces a concrete technical effect because it enables coherent machine-level replacement of distributed constant representations that would otherwise remain numerically inconsistent if only some occurrences were updated or if higher-order compiled values were ignored.

In another aspect, the disclosure provides a safe overwrite subsystem that applies replacement values to detected executable-memory locations under controlled conditions. In disclosed embodiments, the overwrite subsystem can suspend or otherwise coordinate execution threads, temporarily alter page permissions, write replacement bytes to the target location, restore page permissions, flush or invalidate relevant instruction-cache state where appropriate, and resume execution. In alternative embodiments, particularly where simultaneous write-and-execute access is undesirable or disallowed, the overwrite subsystem can generate a shadow copy of the target page, apply the patch to the shadow copy, and redirect execution to the patched shadow page. These operations yield a technical improvement over naive runtime memory editing by coupling target-value replacement with process-state management, permission control, and page-handling logic that reduce the risk of unstable writes, incomplete patch states, or incompatibility with memory-protection policies.

In another aspect, the disclosure provides an integrity and rollback subsystem that records sufficient patch-state information to restore the target executable to its prior state. In preferred embodiments, a patch record includes at least an identified location, original bytes, replacement bytes, and a CRC-32 checksum or other integrity value associated with the patch event. On a rollback event, unload event, comparison-run event, error event, or explicit restore command, the rollback subsystem can restore the original bytes at the recorded locations and verify successful restoration. This provides a concrete technical effect in that the injector can be used not merely as a one-way mutation mechanism, but as a reversible instrumentation framework that supports A/B testing, repeatability analysis, controlled deployment, scientific comparison, and post-run restoration of original executable state.

In another aspect, the disclosure provides an authenticated payload and audit architecture for controlling and documenting runtime modifications. In preferred embodiments, a patch payload containing replacement information is associated with a cryptographic digest and a digital signature, and patch application is conditioned on successful verification of the signature using a trusted verification key. The architecture can further generate an audit record identifying the target process, timing information, applied patches, associated integrity values, and other provenance data. This audit architecture provides a technical effect beyond simple recordkeeping because it distinguishes detection from authorization, authorization from patch execution, and patch execution from policy acceptance or downstream scientific interpretation. As a result, the disclosed system can support authenticated deployment pathways in which a replacement scheme is machine-verified as authorized before modifying executable state, while separately preserving a machine-readable record of what was changed and when it was changed.

In another aspect, the disclosure provides platform-specific loader embodiments for injecting the disclosed functionality into a running or launching target executable. Exemplary embodiments include preload-based loaders, attach-based loaders, platform-specific remote-injection loaders, and architecture-specific scanning implementations. These loaders are disclosed as implementation pathways rather than limiting requirements and enable deployment across heterogeneous operating systems, host environments, and hardware platforms. The disclosed loader flexibility produces a technical benefit because it allows the same constant-replacement framework to be applied in diverse operational settings, including desktop scientific applications, workstation simulations, containerized applications, shared-cluster jobs, and closed binary environments, without requiring a single fixed integration model.

Although the disclosed architecture can be deployed across multiple operating systems, loader paths, executable formats, and runtime environments, the present disclosure does not require every embodiment to support every operating system, every loader mechanism, every executable type, every target-value class, every correction scheme, every page-handling mode, or every deployment context. In some embodiments, a first implementation supports only one operating system and one loader path. In some embodiments, a second implementation supports additional loader paths, additional target-value classes, or additional rollback and audit features. In some embodiments, different deployment modes, target-value classes, and patch-authority states are enabled independently, and an embodiment may omit features unnecessary for a selected deployment while still remaining within the disclosed invention so long as the embodiment preserves the disclosed executable-memory detection, replacement, and control architecture.

In another aspect, the disclosure provides comparative-operation embodiments in which multiple correction schemes, multiple target-value classes, or multiple execution policies can be selected and applied in a controlled testing framework. For example, one run can be performed using original executable values, another using a preferred correction scheme, and another using an alternate or user-defined scheme, with outputs retained for comparison. This comparative architecture yields a concrete technical effect because it transforms runtime patching from a static replacement act into a controlled experimental framework for isolating the impact of selected numerical assumptions on executable behavior while still preserving rollback, reproducibility, and audit support.

In another aspect, the disclosure provides alternative deployment embodiments including source-level preprocessing embodiments, just-in-time compiler integration embodiments, graphics-processing-kernel embodiments, programmable-logic embodiments, continuous-integration embodiments, cloud-service embodiments, and distributed or cluster-scale deployment embodiments. These embodiments are disclosed to show that the inventive concepts are not confined to a single patching location or a single execution stage. Instead, the core inventive architecture resides in the coordinated detection, correction, authorization, patching, restoration, and verification of machine-encoded target values within a compiled or compilation-adjacent execution pipeline.

In preferred Recognition-Physics embodiments, the disclosed architecture uses a Recognition-Physics loop correction parameter derived from an optimal recognition scale and a loop correction ratio to generate corrected values for selected physical constants. In such embodiments, the disclosed injector provides a concrete technical mechanism for propagating those corrected values into already-compiled physics software at runtime. This is technically significant because the injector bridges a gap between theoretical or model-derived correction values and the large installed base of legacy or validated compiled scientific software that would otherwise remain locked to previously embedded constant values.

Accordingly, the disclosure provides a technical solution to a technical problem, and across the method, system, and computer-readable-medium aspects the disclosed inventive concept is the coordinated detection of machine-encoded target values in executable memory, computation of correction-consistent replacements, controlled application of replacement bytes under execution-safe memory conditions, and preservation of rollback and auditability. The technical problem is that compiled physics software commonly contains distributed machine-encoded numerical constants that cannot be reliably or efficiently updated through ordinary source-level methods and that are not adequately addressable through conventional function-hooking or tracing tools.

In some embodiments, the disclosed technology improves computer operation and executable-process control not by merely identifying or reporting numerical values, but by imposing an objective machine workflow for executable-page selection, machine-encoding comparison, candidate classification, authorization-gated replacement generation, controlled page-state transition, postwrite verification, rollback-record creation, and deterministic execution resumption. In some embodiments, the practical technical effect includes reducing the need for source-level rebuilds, reducing operational disruption associated with recompilation and redeployment of validated binaries, and enabling machine-consistent propagation of corrected numerical values across distributed compiled occurrences that would otherwise remain frozen inside already-compiled executable artifacts.

The technical solution is a runtime instrumentation architecture that detects selected target values in executable memory, computes correction-consistent replacements, safely applies those replacements under controlled memory and execution policies, authenticates patch payloads where required, records machine-actionable audit and rollback data, and supports restoration and comparative operation. The resulting technical effects can include elimination of recompilation requirements for selected update scenarios, compatibility with closed or containerized binaries, coherent propagation of corrected values across distributed compiled occurrences, controlled coexistence with process-security policies, deterministic or reproducible patch application behavior, and improved support for validation, scientific comparison, audit, and rollback in deployed computational environments.

The foregoing summary is provided to introduce selected concepts in simplified form and is not intended to identify every disclosed feature, every claimed subject matter grouping, or every implementation detail. Additional features, embodiments, alternatives, fallbacks, technical effects, and claim-supporting details are described in the drawings and detailed description. Unless expressly recited in a particular claim, no statement in this Summary should be construed as requiring any particular operating system, cryptographic primitive, checksum primitive, programming language, instruction-set extension, benchmark result, page size, power range implementation strategy, formal-verification layer, or correction-policy origin. The disclosed embodiments are illustrative and non-limiting, and features described in connection with one embodiment can be used with other embodiments unless technically incompatible.

### BRIEF DESCRIPTION OF THE DRAWINGS

The accompanying drawings are included to illustrate selected embodiments of the disclosed technology and to support the written description of the claimed subject matter. The drawings are schematic and are not necessarily to scale. Relative size, spacing, routing, alignment, and positional relationships shown in the drawings are illustrative unless expressly stated otherwise. Like reference numerals generally identify like or corresponding elements across views where appropriate, although the same functionality may be distributed, subdivided, consolidated, or differently arranged in particular embodiments.

FIG. 1 is a block diagram of an exemplary universal loop-multiplier injector system 100 showing a target executable process 102, executable memory space 104, a constant-pattern library 106, a correction engine 108, a patch engine 110, a security control module 112, an integrity/rollback store 114, an authentication module 116, an audit module 118, a loader interface 120, a configuration input 122, and an output/verification interface 124.

FIG. 2 is a schematic diagram of an exemplary target-process environment 200 showing a process identifier 202, an address-space map 204, an executable page set 206, a page metadata source 208, a scan-selected page 210, a scratch buffer 212, a chunk iterator 214, a candidate location list 216, a permission state record 218, a thread control module 220, and an attach state 222.

FIG. 3 is a block diagram of an exemplary target-value and replacement-generation architecture showing a target-value set 300, a direct constant entry 302, a derived constant entry 304, a power index 306, a reference value generator 308, an IEEE-754 encoder 310, an encoded pattern table 312, an X_opt generator 314, an R_RP store 316, a delta_loop generator 318, a correction factor store 320, a replacement value generator 322, and a replacement encoding 324.

FIG. 4 is a flow-oriented schematic of an exemplary page-scanning and match-detection pipeline showing a page scanner 400, an input page buffer 402, an aligned chunk stream 404, a chunk interpreter 406, a comparison engine 408, a ULP tolerance evaluator 410, a match detector 412, a detection list 414, a candidate record 416, an offset field 418, a target-value identifier field 420, a power identifier field 422, and a detection output 424.

FIG. 5 is a flow diagram of an exemplary patch-application sequence showing a patch controller 500, a thread suspend module 502, a permission change module 504, a writable page state 506, a direct write module 508, a shadow page generator 510, a shadow page 512, a remap module 514, an instruction cache flush module 516, a permission restore module 518, a thread resume module 520, a patch completion output 522, and a checkpoint record 524.

FIG. 6 is a block diagram of an exemplary integrity and rollback subsystem showing an integrity logger 600, a patch record 602, an original bytes field 604, a replacement bytes field 606, a checksum field 608, a CRC-32 generator 610, a patch log store 612, a rollback command input 614, a restore engine 616, a restored bytes output 618, a verification result 620, and an unload trigger 622.

FIG. 7 is a block diagram of an exemplary authenticated payload and audit subsystem showing a payload source 700, a patch payload 702, a digest generator 704, a SHA-256 digest 706, a signature field 708, an Ed25519 verifier 710, a public key store 712, a verification result 714, an audit log generator 716, a signed audit record 718, a process/timestamp field 720, an Ecoh-Ledger interface 722, and an audit archive 724.

FIG. 8 is a block diagram of an exemplary cross-platform loader framework 800 showing a Linux loader 802 with an LD_PRELOAD path 804 and a ptrace path 806, a Windows loader 808 with a Detours path 810 and a remote-thread path 812, a macOS loader 814 with a DYLD_INSERT_LIBRARIES path 816 and a task_for_pid path 818, and an ARM implementation 820 with a SIMD engine selector 822 and a startup injection path 824.

FIG. 9 is a schematic block diagram of an exemplary host computing system 900 showing a processor 902, memory 904, storage 906, an operating system 908, a target physics application 910, an injector binary 912, a network interface 914, a container runtime 916, a job scheduler 918, and a cluster node 920.

FIG. 10 is a deployment diagram showing exemplary deployment contexts including an open-source deployment 1000, a closed-source deployment 1002, a containerized deployment 1004, an HPC cluster deployment 1006, a safety-critical deployment 1008, and an A/B test deployment 1010, together with a comparative-output engine 1012, a patched output set 1014, an unpatched output set 1016, a deployment policy 1018, a user command 1020, a deployment result 1022, and a reproducibility record 1024.

FIG. 11 is a flowchart of an exemplary end-to-end instrumentation method beginning at method start 1100 and including identifying a target executable at 1102, attaching or preloading at 1104, enumerating executable pages at 1106, generating encoded patterns at 1108, scanning aligned chunks at 1110, detecting matches at 1112, computing replacement values at 1114, verifying an authenticated payload at 1116, suspending threads and changing permissions at 1118, writing replacement bytes at 1120, restoring permissions and flushing cache at 1122, logging a patch record at 1124, resuming execution at 1126, and optionally rolling back or ending at 1128.

FIG. 12 is a schematic representation of an exemplary executable page region 1200 before and after patching, including a pre-patch constant instance 1202, a matched byte sequence 1204, an offset location 1206, a replacement byte sequence 1208, a post-patch constant instance 1210, a first occurrence 1212, a second occurrence 1214, a third occurrence 1216, a page-state transition 1218, a tolerance window 1220, a checksum value 1222, and a patch status 1224.

It should be understood that the drawing set is intended to support explanation of the disclosed architectures, methods, subsystems, decision flows, patch states, and deployment modes, and that merged views, subdivided views, or differently arranged views may be used in other embodiments so long as the disclosed subject matter is adequately conveyed. Reference numerals used in the drawings are discussed in additional detail in the Detailed Description.

### DETAILED DESCRIPTION OF THE INVENTION

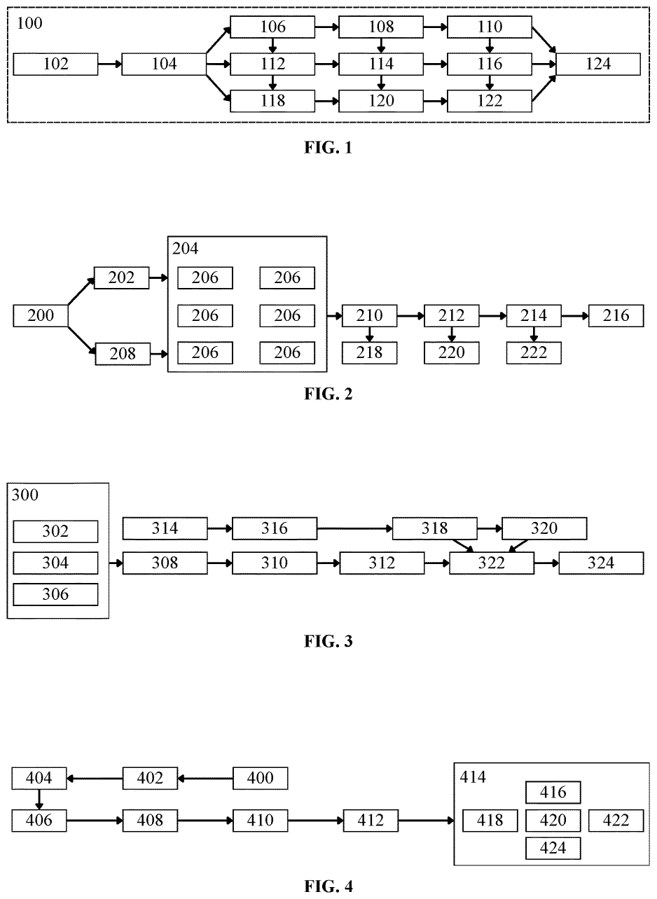

The present disclosure will now be described in further detail with reference to FIGS. 1-12. The drawings are schematic and are presented to illustrate representative structures, states, data flows, control paths, and deployment contexts useful for understanding the disclosed subject matter. The drawings are not necessarily to scale, and relative size, spacing, routing, alignment, and positional relationships are illustrative unless expressly stated otherwise. Unless the context clearly requires otherwise, a reference to a module, engine, subsystem, controller, interface, selector, record, field, state, output, or path may refer to a single component, multiple coordinated components, a local implementation, a distributed implementation, a hardware implementation, a software implementation, or a mixed implementation. Likewise, a reference to a step, operation, state transition, or decision may refer to one event, a repeated event, an iterative event, a batched event, a transaction-scoped event, a thread-scoped event, a process-scoped event, or another machine-executable event sequence consistent with the disclosed logic. The embodiments described herein are illustrative and non-limiting, and features described in connection with one embodiment may be combined with features described in connection with another embodiment unless technically incompatible.

The terminology used herein is intended to provide stable support for claim drafting, examiner review, and figure interpretation. As used herein, a “target executable” means a machine-runnable software artifact, including a standalone executable, shared library, dynamically loaded module, plugin, containerized application image, scheduled job payload, or another compiled or compilation-derived artifact that, during execution, exposes machine-readable memory content that may contain one or more selected numerical values. As used herein, a “target executable process” means the currently running or launching execution context corresponding to the target executable. As used herein, an “executable memory space” includes memory that is executable or otherwise operationally relevant to the machine-level consumption of encoded numeric values by the target executable process, and may include executable pages, code-adjacent literal pools, module-backed numeric regions, mapped pages, or other disclosed memory areas selected under an active policy. As used herein, a “target value” means a selected numerical value subject to detection or replacement and includes a direct constant, a power of a direct constant, a derived constant expression, a context-specific numerical value, a unit-adjusted numerical value, a coefficient, a compiled immediate, or another machine-detectable numeric representation selected for control under the disclosed architecture. As used herein, a “patch payload” means a machine-readable package sufficient to define, support, constrain, or authorize one or more replacement actions, whether such package directly contains replacement bytes, replacement values, correction parameters, target-class identifiers, module selectors, policy selectors, version identifiers, expected counts, or combinations thereof. As used herein, an “authenticated patch payload” means a patch payload associated with a verification mechanism sufficient to determine whether the payload is authorized under an active policy. As used herein, a “rollback record” means a machine-usable record sufficient to restore one or more locations to an earlier state. As used herein, a “comparative run” means a run or coordinated set of runs in which at least two different numerical regimes are evaluated, such as patched versus unpatched, scheme A versus scheme B, or baseline versus corrected. As used herein, a “safe overwrite” means an overwrite performed under controlled permission, execution-state, integrity, and restoration conditions sufficient to reduce risks associated with live modification of a running process. As used herein, a “verification result” means a machine-evaluable output indicating whether a specified criterion has been met, such as signature validity, byte-match validity, write integrity, cache-maintenance completion, or rollback equality. These definitions are descriptive and claim-supportive and are not limited to a single code organization or a single vendor implementation.

The present technology is directed to a concrete machine architecture for propagating corrected or replacement numerical values into already compiled software without requiring source-level modification or recompilation of the target executable. The architecture is particularly useful in scientific and physics-oriented software because such software commonly embeds physically meaningful numeric values in binary form, including direct base constants, precomputed powers of those constants, and context-specific numeric expressions derived from those constants. In preferred embodiments described herein, the architecture is used to propagate Recognition-Physics loop corrections into compiled physics software. However, the disclosed runtime instrumentation architecture is not limited to a single correction theory unless a claim expressly so recites. The core technical contribution resides in the coordinated machine operations by which encoded target values are identified in process memory, screened under objective decision criteria, converted into replacement representations, written under controlled execution conditions, logged in machine-usable form, and restored if required. The present disclosure therefore repeatedly distinguishes between observation and control, detection and authorization, authorization and patch execution, current-use state and historical record state, human-readable output and machine-actionable output, optional features and required features, and verification of authenticity versus policy approval. These distinctions are deliberate and support both technical clarity and prosecution robustness.

FIG. 1 illustrates an exemplary universal loop-multiplier injector system 100. The injector system 100 cooperates with a target executable process 102 and an executable memory space 104 associated with that process. In the illustrated embodiment, injector system 100 includes a constant-pattern library 106, a correction engine 108, a patch engine 110, a security control module 112, an integrity/rollback store 114, an authentication module 116, an audit module 118, a loader interface 120, a configuration input 122, and an output/verification interface 124. These elements are illustrated as distinct functional components to explain the overall architecture, although one or more may be combined, subdivided, virtualized, remotely assisted, containerized, scheduler-mediated, or differently partitioned in particular implementations.

The target executable process 102 is the execution context whose encoded target values are to be evaluated. The target executable process 102 may be a process already running when the injector attaches, a process being launched with preload assistance, a process paused in an initialization stage, a process executing within a container, a process launched by a scheduler, or another process context capable of exposing executable memory content for scanning and controlled modification. In some embodiments, target executable process 102 corresponds to a single-user scientific application running on a workstation. In some embodiments, target executable process 102 corresponds to a production simulation job launched within a managed high-performance computing environment. In some embodiments, target executable process 102 corresponds to a closed-source binary executing inside a containerized runtime environment where direct source-level modification is unavailable. The architecture is useful in each of these contexts because it does not depend on a rebuild of the target executable process 102.

The executable memory space 104 includes at least those pages or regions selected for inspection under the active policy. In some embodiments, executable memory space 104 includes only pages presently marked as readable and executable. In other embodiments, executable memory space 104 additionally includes selected module-backed or code-adjacent regions that, while not strictly executable at the moment of scanning, contain machine-interpretable numeric values used by executable code. In still further embodiments, executable memory space 104 is filtered to exclude pages associated with deny-listed modules, protected subsystems, safety-critical exclusions, prior patch history exclusions, nonpatchable regions, or policy-based scope restrictions. The executable memory space 104 is therefore not merely an undifferentiated memory map. It is a controlled scan universe defined by both process state and policy state.

The constant-pattern library 106 provides reference patterns corresponding to selected target values. In one embodiment, constant-pattern library 106 stores a predetermined set of encoded values corresponding to selected physical constants and selected powers from one through thirty-two of those constants. In another embodiment, constant-pattern library 106 dynamically generates such patterns based on the then-active configuration. In another embodiment, constant-pattern library 106 stores both raw encoded comparison values and metadata describing the target class, power index, scheme association, confidence category, grouping behavior, rollback behavior, expected occurrence count, or allowed deployment mode associated with each encoded value. In still another embodiment, constant-pattern library 106 stores patterns for both direct constants and derived constant expressions, thereby allowing a single runtime architecture to handle bare constants and context-specific compiled numeric forms. The constant-pattern library 106 is therefore not limited to a passive lookup table. It may function as a target-value registry, a pattern cache, a scope filter input, a grouping-rule source, and a scheme-aware comparison resource.

The correction engine 108 computes replacement values using an active correction scheme. In preferred Recognition-Physics embodiments, correction engine 108 computes a correction factor derived from an optimal recognition scale and a loop correction ratio, then applies that factor to selected target values. In other embodiments, correction engine 108 uses a baseline scheme, a comparative scheme, a user-defined scheme, a deployment-test scheme, or another policy-selected scheme. In one implementation, correction engine 108 is local and performs all required arithmetic on the host running target executable process 102. In another implementation, correction engine 108 receives precomputed parameters or precomputed replacement values from an authenticated patch payload. In another implementation, correction engine 108 cooperates with an external source while still remaining the machine component responsible for integrating those parameters or values into the local patch workflow. Thus, correction engine 108 supports both scheme-local and scheme-assisted architectures and may operate in online, offline-preparation, local-only, remote-assisted, or hybrid modes.

The patch engine 110 performs the actual replacement of selected target values within executable memory space 104. Patch engine 110 may write directly into a temporarily writable region, may write into a shadow copy of a page and redirect execution to the shadow copy, may update a mapped module representation, or may use another disclosed write path consistent with the active policy. Patch engine 110 may also perform prewrite validation, postwrite verification, transaction grouping, write-order normalization, path selection between direct and shadow modes, and selective refusal when control conditions are not satisfied. The security control module 112 cooperates with patch engine 110 to ensure that patching occurs under controlled conditions. In preferred embodiments, security control module 112 manages thread coordination, permission changes, remap decisions, instruction-cache maintenance, and failure handling. In some embodiments, security control module 112 also enforces policy distinctions between patch-enabled, detect-only, audit-only, and rollback-required modes.

The integrity/rollback store 114 records original bytes, replacement bytes, checksums, addresses or offsets, transaction identifiers, module identifiers, run identifiers, and other machine-actionable state required to restore the prepatch condition or verify what was changed. In some embodiments, integrity/rollback store 114 is an in-memory transaction store. In some embodiments, integrity/rollback store 114 is a persistent log-backed store. In some embodiments, integrity/rollback store 114 includes both fast local storage for live rollback and persistent archival storage for later audit. The authentication module 116 determines whether a patch payload, replacement policy, or other patch-enabling input is authorized under the active policy. Audit module 118 records machine-readable evidence concerning scan scope, detection events, authorization outcomes, patch events, rollback events, policy state, and configuration state. Loader interface 120 injects or attaches the system into target executable process 102. Configuration input 122 receives user commands, policy settings, target-value definitions, scheme selections, deployment-mode selections, scope selectors, failure policies, and related control inputs. Output/verification interface 124 emits machine-usable outputs, including verification results, patch counts, detection counts, candidate classifications including excluded-by-scope classifications, stale-candidate classifications, awaiting-authorization classifications, verification-required classifications, and count-mismatch classifications, rollback status, run comparisons, policy results, and other operational outputs.

The components of FIG. 1 interact in a disciplined way. In a representative embodiment, loader interface 120 first obtains sufficient runtime foothold to inspect target executable process 102. Configuration input 122 then defines or confirms the active target-value scope and the active deployment policy. Constant-pattern library 106 then exposes the reference patterns required for comparison. Authentication module 116 determines whether any required payload authorization has been satisfied. Security control module 112 establishes the scanning and writing conditions permitted for the current run. Correction engine 108 computes or confirms replacement values for the active scheme. Patch engine 110 applies the replacements at selected locations. Integrity/rollback store 114 records the machine state required for later restoration or proof of modification. Audit module 118 records the run, and output/verification interface 124 emits the resulting machine-actionable status. These interactions are particularly useful because they separate duties. The reference generation path is not the same as the write path. The authorization path is not the same as the comparison path. The restoration path is not the same as the reporting path. That separation reduces ambiguity and creates clearer technical boundaries for both implementation and claim drafting.

FIG. 2 illustrates an exemplary target-process environment 200. The target-process environment 200 includes a process identifier 202, an address-space map 204, an executable page set 206, a page metadata source 208, a scan-selected page 210, a scratch buffer 212, a chunk iterator 214, a candidate location list 216, a permission state record 218, a thread control module 220, and an attach state 222. Process identifier 202 identifies the target process. Address-space map 204 represents the memory layout of the target process. Executable page set 206 is a filtered set of pages or regions that may be scanned. Page metadata source 208 supplies metadata used for that filtering. Scan-selected page 210 is an individual page or region chosen for active scan processing. Scratch buffer 212 stores a local scan copy of scan-selected page 210. Chunk iterator 214 traverses scratch buffer 212. Candidate location list 216 stores candidate locations found during scanning. Permission state record 218 stores protection or access-state information useful for restoration. Thread control module 220 coordinates target-thread behavior during sensitive operations. Attach state 222 records whether the system is attached at launch, attached at runtime, waiting in a paused state, resumed after patching, in pre-main execution, in post-main execution, in unload handling, or otherwise situated in the target lifecycle.

Process identifier 202 may be generated from or associated with a process ID, process handle, container-associated process reference, scheduler-provided job reference, launch descriptor, or other context token sufficient to establish a binding between injector operations and the correct execution context. Address-space map 204 may be obtained through operating system APIs, memory maps, loader inspection, remote process query interfaces, module iterators, or equivalent facilities. In one embodiment, address-space map 204 includes start addresses, end addresses, page protections, module identities, file mappings, and region types. In another embodiment, address-space map 204 includes additional information such as copy-on-write status, shared mapping indicators, relocation flags, JIT-origin indicators, debugger-visible metadata, or trust classifications. Such metadata is useful because not all pages that are executable are equally suitable for patching. Some pages may be owned by disallowed modules. Some may be ephemeral. Some may be candidates only for detect-only operation. Some may require a shadow-page path rather than a direct-write path. Some may be excluded because they belong to modules that are outside an approved scope. Accordingly, page metadata source 208 is not merely descriptive. It supplies information used by subsequent control logic.

Executable page set 206 is derived by applying selection criteria to address-space map 204. In one embodiment, executable page set 206 includes all readable and executable pages not excluded by policy. In another embodiment, executable page set 206 excludes pages associated with system libraries, integrity-protected modules, explicitly denied address ranges, or previously patched regions under a no-repatch policy. In another embodiment, executable page set 206 is limited to modules selected by configuration input 122. In another embodiment, executable page set 206 includes a first class of pages eligible for patching and a second class eligible only for detection and audit. In another embodiment, executable page set 206 includes only pages belonging to a module scope explicitly associated with a selected target-value class. The distinction between these classes is useful because it allows the system to observe values in a broad scope while patching only an approved scope. This may be desirable in regulated environments, staged deployments, comparative studies, or environments where only a subset of the code base has been approved for runtime modification.

Scan-selected page 210 is copied or otherwise stabilized into scratch buffer 212 in preferred embodiments. Scratch buffer 212 allows scanning to proceed on a local snapshot rather than against live process memory that may be changing. In one embodiment, scratch buffer 212 contains a byte-accurate copy of scan-selected page 210. In another embodiment, scratch buffer 212 contains a page-normalized or region-normalized copy augmented with metadata describing the page origin and permissions. In another embodiment, scratch buffer 212 is one of a rotating set of buffers that allow multiple pages to be scanned in sequence or in parallel while preserving page identity and scan order. The use of scratch buffer 212 is especially useful because it separates candidate discovery from later patching. Candidate discovery can therefore be deterministic with respect to the snapshot even if later write eligibility depends on live-process revalidation.

Chunk iterator 214 traverses scratch buffer 212 according to a selected granularity and alignment rule. In preferred embodiments, chunk iterator 214 advances in aligned 8-byte increments because the disclosed numeric representation of interest is IEEE-754 double precision. In other embodiments consistent with the present disclosure, chunk iterator 214 may evaluate aligned positions while using wider internal loads or vectorized comparisons. Candidate location list 216 stores candidate records representing locations that satisfy one or more comparison criteria. In some embodiments, candidate location list 216 stores records in discovery order. In some embodiments, candidate location list 216 stores records in normalized address order for deterministic later processing. In some embodiments, candidate location list 216 also stores scope metadata such as page identity, module identity, occurrence grouping, detect-only status, stale-candidate flags, or policy-based exclusion reasons.

Permission state record 218 captures the prepatch or current permission state of the page. In one embodiment, permission state record 218 stores read, write, execute, and copy-on-write states. In another embodiment, permission state record 218 stores additional mapping information sufficient to restore a prior page posture after patching or to document the prepatch memory-protection state in audit records. Thread control module 220 is useful both during scanning and patching. During scanning, it may merely track execution posture or defer scanning of unstable regions. During patching, it may suspend threads, coordinate safe points, or otherwise establish a safe write condition. Attach state 222 is important because the timing of injection can affect which pages are visible, whether some modules are fully initialized, whether a safe stop-the-world operation is feasible, and whether pre-main patching is available. In some embodiments, attach state 222 influences whether a patch is performed immediately or deferred until a later execution point. In some embodiments, attach state 222 also affects whether the system treats target values as likely stable, likely transitional, or likely stale-prone.

FIG. 3 illustrates an exemplary target-value and replacement-generation architecture that supports direct constants, derived values, and power-specific handling. Target-value set 300 includes direct constant entry 302, derived constant entry 304, power index 306, reference value generator 308, IEEE-754 encoder 310, encoded pattern table 312, X_opt generator 314, R_RP store 316, delta_loop generator 318, correction factor store 320, replacement value generator 322, and replacement encoding 324. Direct constant entry 302 corresponds to one or more selected base values. Derived constant entry 304 corresponds to one or more selected derived numeric values. Power index 306 specifies a power class used for reference and replacement generation. Reference value generator 308 produces the reference numeric value. IEEE-754 encoder 310 converts that reference value into a machine-comparable encoding. Encoded pattern table 312 stores one or more such encodings. X_opt generator 314 and R_RP store 316 support the preferred Recognition-Physics embodiment. Delta_loop generator 318 computes a loop correction parameter. Correction factor store 320 stores the factor derived from that parameter. Replacement value generator 322 computes the replacement value, and replacement encoding 324 represents the final machine-formatted bytes to be written.

The presence of direct constant entry 302 and derived constant entry 304 is significant. It allows the target-value architecture to support not only bare constants but also compiled numerical expressions that are already materialized in binary form. In many scientific executables, meaningful values do not survive compilation as a single source-level symbol. Instead, they may appear as precomputed terms, unit-adjusted coefficients, normalized values, scaled values, or module-specific numerics derived from one or more base constants. The inclusion of derived constant entry 304 therefore provides broader and more practical support for binary-level instrumentation. The invention is not limited to only those occurrences that exactly match a textbook constant. It is directed to machine-detectable values selected for control under the disclosed architecture.

Power index 306 is particularly useful in compiled-physics contexts because precomputed powers of constants are often embedded directly in a binary. In preferred embodiments, the disclosed range is one through thirty-two. This range is sufficient to support many practical compiled forms without requiring the target application to recompute those values dynamically. Reference value generator 308 can therefore generate both C and C\hat{ }n for a selected target C and selected power n. In preferred Recognition-Physics embodiments, replacement value generator 322 then computes replacement=(C*(1−delta_loop))\hat{ }n for the same selected power n. This allows the injector to patch a binary in a way that preserves multiplicative consistency across multiple compiled occurrences of the same conceptual parameter. That is a concrete technical advantage over approaches that would modify only a base value and leave higher-order compiled numerics unchanged.

Reference value generator 308 may operate under several data sources. In one embodiment, direct constant entry 302 or derived constant entry 304 includes the original numeric reference directly. In another embodiment, the original reference is computed from symbolic inputs. In another embodiment, the reference is imported from a payload or scheme registry. In another embodiment, direct constant entry 302 and derived constant entry 304 each include metadata indicating whether the target is patch-enabled, detect-only, grouping-required, or fallback-only. IEEE-754 encoder 310 encodes each reference according to the preferred disclosed machine representation. Encoded pattern table 312 may store exact encodings and may also store comparison metadata such as allowed power range, target identifier, scheme identifier, grouping behavior, scope behavior, expected occurrence counts, or whether the target is patch-enabled, detect-only, or audit-only. Encoded pattern table 312 may be cached per run, per target application, per module, or per scheme version. In some embodiments, encoded pattern table 312 is built once per run and reused across multiple pages. In other embodiments, encoded pattern table 312 is selectively rebuilt when target-value scope changes. In another embodiment, multiple encoded pattern tables 312 corresponding to different correction schemes are maintained for comparative operation.

X_opt generator 314, R_RP store 316, and delta_loop generator 318 support the preferred Recognition-Physics correction path. In a preferred embodiment, X_opt generator 314 computes or retrieves an optimal recognition scale, R_RP store 316 provides a loop correction ratio, and delta_loop generator 318 calculates a loop correction parameter from those values. Correction factor store 320 then stores a factor based on one minus delta_loop. Replacement value generator 322 uses that correction factor to transform the original target value into its replacement. Replacement encoding 324 then transforms the replacement value into the machine representation to be written by patch engine 110. In some embodiments, these calculations are performed at runtime. In other embodiments, some or all of the resulting values are provided in an authenticated patch payload 702. In still other embodiments, a hybrid mode is used where the scheme identifier is provided by payload and the arithmetic is performed locally. The architecture therefore supports locally computed, remotely provisioned, and hybrid replacement workflows. This flexibility is useful for cluster deployment, controlled validation, and multi-scheme comparison.

FIG. 4 illustrates an exemplary page-scanning and match-detection pipeline. Page scanner 400 receives input page buffer 402 and produces aligned chunk stream 404. Chunk interpreter 406 interprets chunks from aligned chunk stream 404 as candidate machine representations. Comparison engine 408 compares those candidates against entries in encoded pattern table 312. ULP tolerance evaluator 410 applies a tolerance rule. Match detector 412 identifies candidate matches. Detection list 414 stores one or more candidate records 416. Each candidate record 416 includes offset field 418, target-value identifier field 420, power identifier field 422, and detection output 424.

Page scanner 400 may scan sequentially, page by page, or may process multiple pages concurrently while preserving run ordering in candidate records. Input page buffer 402 is preferably derived from scratch buffer 212 associated with a specific scan-selected page 210. Aligned chunk stream 404 may be strictly aligned to 8-byte boundaries in the preferred double-precision embodiment. In one embodiment, alignment is enforced to reduce false positives and reflect typical compiler-generated double placement. In another embodiment, internally vectorized loads may still be logically reduced to aligned 8-byte candidate positions. In another embodiment, alignment policy may exclude misaligned values even if they numerically resemble a target pattern, thereby reducing spurious patch candidates. Chunk interpreter 406 interprets each candidate chunk according to the active representation policy. In preferred embodiments, chunk interpreter 406 interprets candidate chunks as IEEE-754 double-precision values. The architecture is disclosed with this representation because the underlying draft support is grounded in that representation and because scientific executables frequently use it. Comparison engine 408 may compare candidate chunks to one encoded pattern at a time or to multiple patterns in parallel. In some embodiments, comparison engine 408 is accelerated using vector instructions or SIMD broadcast-and-compare operations. In other embodiments, comparison engine 408 uses scalar comparisons. The particular implementation is not limiting. The disclosed point is that machine-readable chunk values are compared to machine-readable target encodings rather than relying on source-level symbol interception. ULP tolerance evaluator 410 then determines whether a candidate is within the permitted tolerance. In the preferred embodiment, the tolerance is plus or minus one ULP. That preferred tolerance supports a practical balance between catching intended compiled encodings and limiting accidental matches. The detection logic thereby uses an objective numeric boundary rather than an informal similarity judgment. In some embodiments, tolerance window 1220 associated with FIG. 12 reflects the same tolerance logic used by ULP tolerance evaluator 410. In some embodiments, the tolerance rule is fixed for a selected deployment mode. In some embodiments, the tolerance rule is selectable through configuration input 122 but remains anchored to the disclosed machine-precision comparison framework.

Match detector 412 can apply additional criteria beyond raw numeric match. In one embodiment, a candidate is accepted as a match when the candidate satisfies the tolerance rule and falls within an allowed module scope, and the candidate is otherwise rejected or retained as detect-only under the active policy. In another embodiment, a candidate must satisfy the tolerance rule and also avoid a region class marked nonpatchable. In another embodiment, a candidate must satisfy the tolerance rule and also satisfy a grouping requirement such as being one member of a required multi-occurrence set. In another embodiment, match detector 412 tags a candidate as a numerical match but detection output 424 marks it as detect-only because the active policy does not permit patching of that class. In another embodiment, detection output 424 can distinguish patch-eligible, detect-only, excluded-by-policy, excluded-by-scope, stale-after-rescan, duplicate-grouped, duplicate-ignored, awaiting-authorization, inconsistent-occurrence-count, verification-required, count-mismatch, or stale-candidate states. Thus, detection output 424 provides a machine vocabulary for downstream control and avoids collapsing all numeric similarity events into one undifferentiated category.

Offset field 418 identifies the location of the candidate, either as a page offset, process address, module-relative offset, or another machine-usable locator. Target-value identifier field 420 identifies which target-value class the candidate corresponds to. Power identifier field 422 identifies the relevant power or exponent class, if any. Detection list 414 may store candidate records 416 in the order found or in a later normalized order. In some embodiments, candidate list normalization occurs before patch selection so that runs are deterministic. In some embodiments, candidate records 416 also store associated page or module identifiers derived from page metadata source 208 even though those items are not separately numbered in the figure. This is consistent with the present disclosure because the numbered figure elements identify the principal structures while supporting data can be stored within or associated with those structures. In some embodiments, detection list 414 is retained even when no patch occurs so that the system can support detect-only reporting, audit-only operation, or later user review.

The page-scanning and match-detection pipeline also supports filtering and grouping logic. In one embodiment, detection list 414 is grouped by target-value identifier field 420 so that all occurrences of the same value class can be considered together. In another embodiment, grouping also uses power identifier field 422 so that C, C\hat{ }2, and C\hat{ }3 can be tracked as distinct yet related compiled occurrences. In another embodiment, candidates are grouped by page, module, transaction scope, or scheme scope. Grouping is useful because in some policies a patch should only proceed if all required occurrences in a group are patchable. In another policy, partial group patching is permitted but must be explicitly recorded. In another policy, detection list 414 is produced for reporting only, and no patch selection occurs. In another embodiment, group consistency may be evaluated against expected occurrence counts provided through patch payload 702 or configuration input 122, and a count mismatch may prevent patch commitment for the affected group while preserving grouped candidate records for detect-only reporting. These alternatives provide robust support for claim drafting around grouping, consistency, transactionality, and policy control.

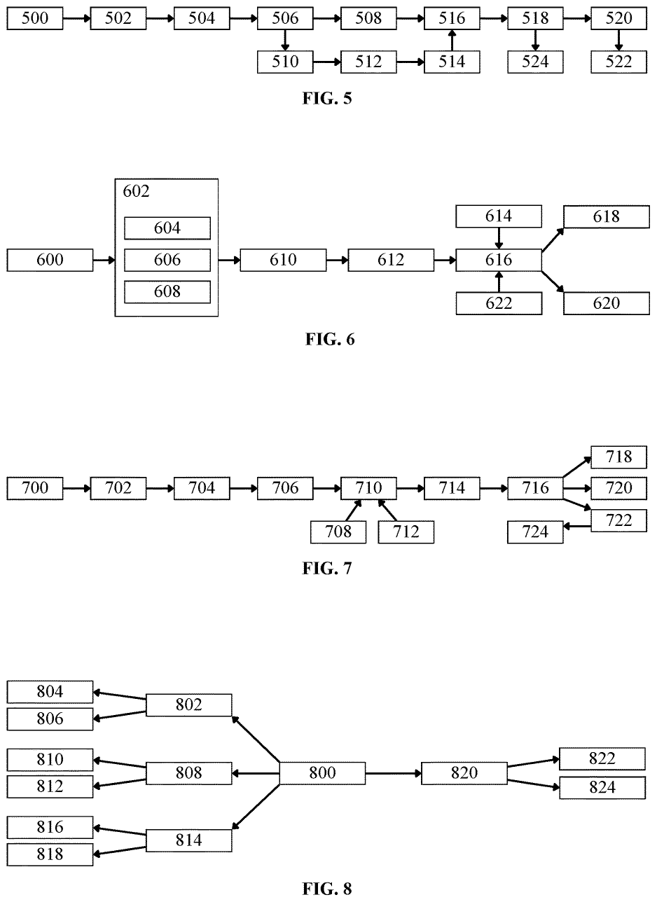

FIG. 5 illustrates an exemplary patch-application sequence. Patch controller 500 orchestrates the patch sequence. Thread suspend module 502 coordinates the target process execution state. Permission change module 504 transitions the page to writable page state 506 where appropriate. Direct write module 508 applies an in-place replacement where the active policy allows. Shadow page generator 510 creates shadow page 512 where a shadow path is preferred or required. Remap module 514 redirects execution or mapping to the patched shadow page 512. Instruction cache flush module 516 performs cache maintenance. Permission restore module 518 restores the intended page state. Thread resume module 520 resumes execution. Patch completion output 522 communicates completion state. Checkpoint record 524 stores transaction-level patch state. Patch controller 500 is preferably responsible for converting a set of patch-eligible candidates into a controlled patch transaction. In one embodiment, patch controller 500 first revalidates that the bytes at each candidate still correspond to the expected prepatch content. This can be done by comparing current live bytes to a stored original candidate representation. This revalidation is useful because a candidate found in scratch buffer 212 may become stale if the process changes between scanning and patching. In another embodiment, patch controller 500 verifies that authorization is current and has not expired or been revoked. In another embodiment, patch controller 500 checks a policy constraint such as maximum patch count, allowed module scope under the active policy, required all-or-nothing grouping, permitted occurrence counts, or active deployment mode, and a mismatch between an observed occurrence count and an expected occurrence count can cause refusal or detect-only reclassification for the affected group, and a candidate outside the allowed module scope is refused or retained as detect-only. In another embodiment, patch controller 500 checks whether an earlier patch has already altered the same location. In another embodiment, patch controller 500 determines whether the direct-write path or the shadow path should be used for the current page. These objective checks prevent the system from writing blindly into memory based on stale or incomplete assumptions.

Thread suspend module 502 may operate in several modes. In a full-stop mode, all noncontroller threads are suspended. In a scoped-stop mode, only threads associated with a selected module or region are suspended. In a safe-point mode, threads are coordinated to avoid executing affected regions during patching. In a pre-main mode, thread coordination may be minimal because the process has not yet begun ordinary application execution. In a detect-only mode, thread suspend module 502 may remain inactive because no write will occur. These alternative modes are useful because not all platforms and not all deployments will support or require the same thread-control posture. The presence of thread suspend module 502 in the architecture supports precise claims about coordinated patch timing without limiting all embodiments to one style of suspension. In some embodiments, thread suspend module 502 also records suspend success or failure into checkpoint record 524 or audit module 118.

Permission change module 504 is responsible for creating writable page state 506 where direct writing is permitted. In some embodiments, writable page state 506 also retains execute capability. In other embodiments, writable and executable permissions are not simultaneously present, and the system transitions through permissible states under the local platform model. In still other embodiments, direct write is disallowed by policy even if technically possible, and permission change module 504 therefore signals patch controller 500 to use the shadow path. Direct write module 508 then writes replacement bytes to the selected location when the direct-write path is active. The direct-write path is useful for speed and simplicity in environments where it is safe and permitted. In some embodiments, direct write module 508 operates on one candidate at a time. In some embodiments, direct write module 508 writes a grouped set of candidates within the same page as one coordinated batch.

Shadow page generator 510 is useful in stricter protection environments or in policies that prefer not to alter a currently executing page in place. In one embodiment, shadow page generator 510 copies the page to shadow page 512, applies the replacement to the shadow page 512, and then remap module 514 redirects the process to consume the shadow page 512 in place of the original page. In another embodiment, remap module 514 updates an address mapping. In another embodiment, remap module 514 updates a module or region reference used by the process. In another embodiment, the shadow path is selected automatically when permission change module 504 cannot safely obtain writable page state 506. The precise remap mechanism may vary by platform. What matters is that a patched code or literal source becomes operational without requiring in-place modification of the original execute source. This is a concrete technical fallback path that strengthens both enablement and robustness.

Instruction cache flush module 516 ensures that instruction fetch or related cache state is coherent with the newly patched bytes when required by the platform. Permission restore module 518 returns the page or mapping to the intended postpatch state. In a direct-write embodiment, this often means restoring the original protection profile. In a shadow-page embodiment, this means ensuring the postremap state has the intended execution permissions and that transient writable permissions are not left enabled. Thread resume module 520 then allows the target process to continue. Patch completion output 522 can indicate success, partial success, refusal, retry-needed, stale-candidate refusal, authorization failure, rollback-triggered restoration, direct-write completion, shadow-path completion, or another specific result. Checkpoint record 524 stores sufficient state to prove what path was taken and to support later rollback or fault analysis. In some embodiments, checkpoint record 524 includes transaction order, path type, affected page identity, grouping identity, module identity, prewrite verification result, or postwrite verification result.

The patch sequence of FIG. 5 also supports objective decision rules. In one embodiment, if any candidate in a required group fails revalidation, the whole group is refused. In another embodiment, if direct write fails, the system attempts a shadow-page path if and only if deployment policy 1018 allows it. In another embodiment, if instruction cache flush module 516 reports failure, thread resume module 520 does not execute until rollback or remediation is completed. In another embodiment, a postwrite verification compares the actual bytes at the target location to replacement encoding 324 before patch completion output 522 is set to success, and a patch write is accepted as committed only when the actual bytes match replacement encoding 324 and corresponding rollback data has been stored. In another embodiment, patch controller 500 updates checkpoint record 524 after each location and can therefore support fine-grained rollback if a later location in the same transaction fails. In another embodiment, patch completion output 522 is withheld until integrity/rollback store 114 confirms storage of the corresponding rollback data. This kind of ordered, criteria-driven control is significant because it demonstrates that the disclosed invention is not a generic “patch memory” concept, but rather a reproducible, failure-aware machine process.

FIG. 6 illustrates an exemplary integrity and rollback subsystem. Integrity logger 600 creates patch record 602 for each patch or patch group. Patch record 602 includes original bytes field 604, replacement bytes field 606, and checksum field 608. CRC-32 generator 610 computes checksum data for the record or the relevant bytes. Patch log store 612 stores the resulting records. Rollback command input 614 triggers restoration. Restore engine 616 uses the stored records to restore the target state. Restored bytes output 618 reports restoration results. Verification result 620 confirms whether restoration met the required criteria. Unload trigger 622 can automatically initiate rollback.

Original bytes field 604 is important because it captures the exact machine content that existed before patching. Replacement bytes field 606 is important because it captures the machine content intended to replace the original. Checksum field 608 and CRC-32 generator 610 provide a compact integrity mechanism for verifying record consistency and, in some embodiments, postrestore correctness. Patch log store 612 may be purely in memory, persisted to storage 906, mirrored to a remote location, or partitioned between fast-access transaction storage and archived storage. In some embodiments, patch log store 612 stores one record per candidate location. In some embodiments, patch log store 612 stores one record per transaction and includes multiple candidate entries within patch record 602. Rollback command input 614 may originate from a direct user command, an API call, an automation signal, an end-of-run policy, an error handler, an A/B testing controller, or unload trigger 622. Restore engine 616 may restore all patched locations, a transaction group, a module subset, or another policy-defined scope.

The rollback subsystem supports multiple restoration strategies. In an all-or-nothing mode, restore engine 616 restores every location in a committed transaction and treats partial restoration as failure. In a selective mode, restore engine 616 restores only the locations belonging to a selected target-value identifier field 420 or power identifier field 422. In a comparative mode, restore engine 616 restores all patched locations after a first run so that a second run can proceed on the original state. In a fault-recovery mode, restore engine 616 is invoked immediately after a failed postwrite verification or failed authorization state change. Verification result 620 may require exact byte equality with original bytes field 604, may require checksum agreement based on checksum field 608, or may require both. In some embodiments, restore engine 616 revalidates that the current bytes correspond to replacement bytes field 606 before writing original bytes field 604, thereby guarding against unexpected external modification. In another embodiment, restore engine 616 can refuse selective rollback when a policy requires transaction-integrity restoration.

The role of checksum field 608 and CRC-32 generator 610 should be understood properly. The disclosed invention does not depend on CRC-32 as an abstract novelty point. Rather, CRC-32 is a preferred disclosed integrity primitive for a concrete rollback architecture. The broader technical significance is that the system maintains machine-restorable original content and machine-checkable record integrity so that patching can be reversed reliably and demonstrably. This supports production use, A/B testing, scientific reproducibility, and controlled deployment. In some embodiments, checksum field 608 is per patch. In some embodiments, checksum field 608 is per transaction. In some embodiments, both granularities are used. In some embodiments, verification result 620 also includes scope information indicating whether the restoration was complete, partial, or refused. The present disclosure supports all such variants.

FIG. 7 illustrates an exemplary authenticated payload and audit subsystem. Payload source 700 provides patch payload 702. Digest generator 704 computes SHA-256 digest 706. Signature field 708 contains a digital signature associated with patch payload 702. Ed25519 verifier 710 validates the signature using public key store 712. Verification result 714 indicates whether the payload is authenticated. Audit log generator 716 creates signed audit record 718.

Process/timestamp field 720 records process identity and time-related data. Ecoh-Ledger interface 722 supports export or linkage to a transparency or provenance system. Audit archive 724 stores the resulting records.

Patch payload 702 may contain different kinds of information in different embodiments. In one embodiment, patch payload 702 directly contains replacement values or replacement bytes for selected targets. In another embodiment, patch payload 702 contains scheme parameters from which correction engine 108 computes the replacement values. In another embodiment, patch payload 702 contains both target definitions and policy directives such as allowed modules, allowed target classes, detect-only classes, group-completeness requirements, required rollback behavior, expected occurrence counts, or approved deployment modes. In another embodiment, patch payload 702 also includes version identifiers, module identities, transaction constraints, or comparative-run identifiers. Thus, patch payload 702 is a flexible machine-readable control artifact rather than a single rigid file format.

Digest generator 704 and SHA-256 digest 706 support authentication and audit integrity in the preferred embodiment. Signature field 708 and Ed25519 verifier 710 support a concrete signature-verification path. Public key store 712 may be local, remotely provisioned, hardware-backed, bundled with injector binary 912, or managed by enterprise or cluster policy.

Verification result 714 may be used differently depending on deployment policy 1018. In a strict fail-closed mode, verification result 714 must be positive before patch engine 110 is enabled. In a detect-only mode, verification result 714 may still be recorded even though no writes are attempted. In a permissive testing mode, verification result 714 may be advisory for local experiments while still being mandatory in production. The disclosure therefore distinguishes cryptographic validity from policy acceptance. A payload can be cryptographically valid yet not approved for a specific deployment scope. Conversely, a detect-only scan may proceed without a patch-authorized payload. These distinctions are useful for claim support and operational clarity.

Audit log generator 716 creates signed audit record 718 representing the machine events of a run. In one embodiment, signed audit record 718 includes target process identity, target executable identity, active payload version, target-value scope, candidate count, patch count, rollback count, authorization outcome, and scheme identity. In another embodiment, signed audit record 718 includes hashes of patch records or transactions. In another embodiment, signed audit record 718 records which modules were scanned, which were skipped, which were patched, which were refused, and why. Process/timestamp field 720 may include process ID, host identity, job identity, launch time, attach time, patch start time, patch completion time, rollback time, and audit finalization time. Ecoh-Ledger interface 722 is useful where provenance records should be externally anchored or cross-linked. Audit archive 724 may store structured machine-readable records, rendered human-readable reports, or both. The distinction between these is important. Machine-readable records control automation and reproducibility. Human-readable records support review but do not by themselves drive patching. In some embodiments, audit archive 724 also stores detect-only findings, refused transactions, stale-candidate events, or comparative-run identifiers.

FIG. 8 illustrates an exemplary cross-platform loader framework 800. Linux loader 802 supports LD_PRELOAD path 804 and ptrace path 806. Windows loader 808 supports Detours path 810 and remote-thread path 812. macOS loader 814 supports DYLD_INSERT_LIBRARIES path 816 and task_for_pid path 818. ARM implementation 820 includes SIMD engine selector 822 and startup injection path 824. These paths are exemplary and should not be read as requiring every listed platform mechanism in every embodiment. The technical point is that the injector architecture can be introduced at process launch, process attach, or another suitable execution point.

Linux loader 802 via LD_PRELOAD path 804 is useful where the injector should be present before main program execution, thereby allowing early scanning and early patching. Linux loader 802 via ptrace path 806 is useful where a running process is to be instrumented after launch. Windows loader 808 via Detours path 810 is useful where a process-creation or function-interception-based loader path is preferred. Windows loader 808 via remote-thread path 812 is useful where a runtime attach path is desired. macOS loader 814 via DYLD_INSERT_LIBRARIES path 816 similarly supports launch-time injection, while task_for_pid path 818 supports attach-oriented control. ARM implementation 820 and SIMD engine selector 822 are useful because scan performance may depend on the processor architecture. Startup injection path 824 illustrates that architecture-specific initialization handling can be used while preserving the same underlying detection and patch logic.

Loader framework 800 also supports policy-based loader selection. In one embodiment, configuration input 122 selects allowed loader modes. In another embodiment, loader interface 120 chooses among paths based on current privileges. In another embodiment, attach state 222 is used to decide whether a pre-main patch window is available. In another embodiment, some loader paths are permitted only for detect-only operation while others are allowed for full patching. In another embodiment, a loader path may be chosen because it better supports deterministic page ordering or pre-execution patch timing. These alternatives show that loader selection is not merely a deployment convenience. It is part of the technical control architecture because loader timing and loader privilege can influence scan scope, write safety, and reproducibility.

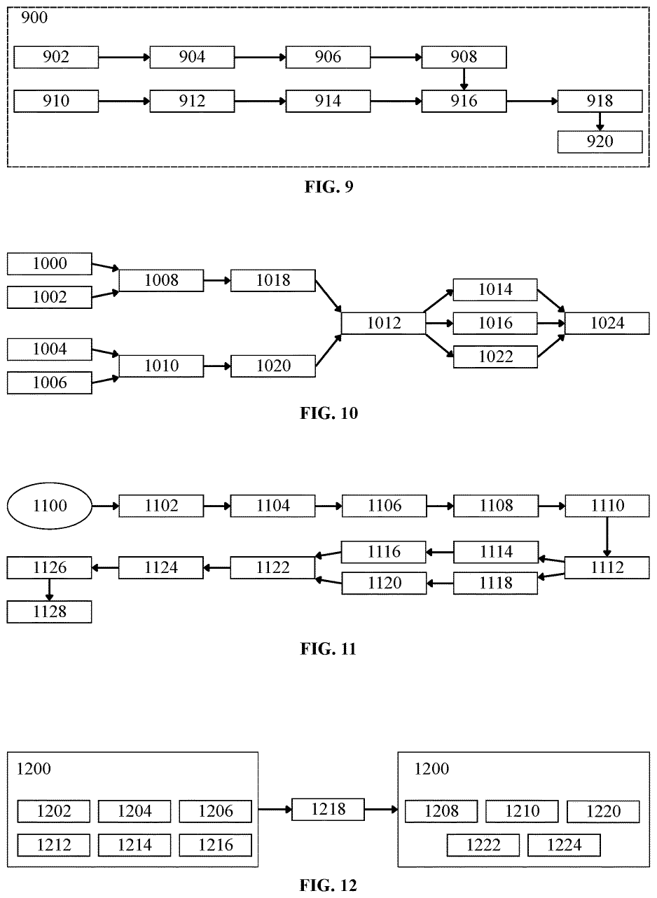

FIG. 9 illustrates an exemplary host computing system 900. Host computing system 900 includes processor 902, memory 904, storage 906, operating system 908, target physics application 910, injector binary 912, network interface 914, container runtime 916, job scheduler 918, and cluster node 920. Processor 902 executes target physics application 910 and injector binary 912. Memory 904 stores runtime state including scratch buffers, encoded pattern tables, candidate lists, patch transactions, rollback records, and audit data. Storage 906 stores binaries, configuration data, key material, payloads, and archived outputs. Operating system 908 provides process and memory primitives needed for attach, page enumeration, permission changes, remaps, and cache control. Target physics application 910 is the application under instrumentation. Injector binary 912 is the executable embodiment of injector system 100 or a component thereof. Network interface 914 permits remote payload retrieval, key retrieval, audit export, or centralized policy coordination. Container runtime 916 supports deployment in containers. Job scheduler 918 supports deployment in scheduled compute environments. Cluster node 920 illustrates that the target may run within a distributed or multi-node setting.

The host computing system 900 is disclosed to support multiple deployment models. In a local workstation embodiment, injector binary 912 and target physics application 910 are both local, and network interface 914 may be unused. In a remote-assisted embodiment, injector binary 912 performs local scanning and patching while using network interface 914 to retrieve signed payloads or transmit audit records. In a container embodiment, container runtime 916 hosts target physics application 910, and injector binary 912 may be inserted through environment variables, bind mounts, image inclusion, or analogous container-compatible mechanisms. In an HPC embodiment, job scheduler 918 may set preload variables or runtime options for multiple jobs, and each cluster node 920 may locally execute the same patching logic under a common policy. In another embodiment, a scheduler profile may determine whether the injector runs in detect-only mode or patch-enabled mode on the cluster node 920. The inclusion of these elements supports claims directed to local, remote, containerized, and scheduler-integrated operation without requiring separate inventive concepts for each.

FIG. 10 illustrates representative deployment contexts and outputs. Open-source deployment 1000 represents environments where source code exists but runtime patching is still preferred. Closed-source deployment 1002 represents environments where source modification is unavailable or disallowed. Containerized deployment 1004 represents environments where the target application is run inside a container. HPC cluster deployment 1006 represents environments where the target application is launched across nodes under scheduler control. Safety-critical deployment 1008 represents environments emphasizing strict authorization, logging, rollback, and proof of change. A/B test deployment 1010 represents environments where patched and unpatched runs are compared. Comparative-output engine 1012 receives or organizes run outputs. Patched output set 1014 corresponds to runs with the patch active. Unpatched output set 1016 corresponds to runs without the patch or after rollback. Deployment policy 1018 governs which operational mode applies. User command 1020 may initiate a run or select a policy mode. Deployment result 1022 records the result. Reproducibility record 1024 records enough information to repeat or evaluate the run.

Deployment policy 1018 may control many aspects of system behavior. In one embodiment, deployment policy 1018 specifies whether authentication is mandatory. In another embodiment, deployment policy 1018 specifies whether incomplete occurrence groups can be patched. In another embodiment, deployment policy 1018 selects detect-only, patch-enabled, audit-only, comparative, rollback-on-exit, or persistent-patch mode. In another embodiment, deployment policy 1018 controls whether automatic rollback occurs at run completion. In another embodiment, deployment policy 1018 defines allowed target classes, module scopes, patch count ceilings, failure handling, or audit requirements. User command 1020 may directly select a mode or may indirectly trigger a predefined policy profile. Deployment result 1022 may therefore communicate not only success or failure, but also whether the run was detect-only, partially patched, refused by policy, rolled back automatically, completed with a stored reproducibility record 1024, or completed with comparative-output data.

Comparative-output engine 1012 is useful because it separates numeric-regime control from output evaluation. In one embodiment, comparative-output engine 1012 simply stores patched output set 1014 and unpatched output set 1016 for later review. In another embodiment, comparative-output engine 1012 computes diffs, tolerances, statistical summaries, or pass/fail criteria. In another embodiment, deployment policy 1018 requires that any production patch deployment be preceded by at least one A/B test deployment 1010. In another embodiment, comparative-output engine 1012 stores multiple patched output sets corresponding to multiple correction schemes. Reproducibility record 1024 may store patch counts, target-value version, payload version, module scope, timestamps, authorization state, comparative-run identifiers, and other machine-usable details. This creates an auditable bridge between the patch control layer and the scientific or engineering outputs of the target application.

FIG. 11 illustrates an exemplary end-to-end instrumentation method. Method start 1100 begins the controlled run. Identify target executable 1102 selects the target executable or process. Attach or preload 1104 establishes injector presence. Enumerate executable pages 1106 derives the scan scope. Generate encoded patterns 1108 prepares comparison values. Scan aligned chunks 1110 scans the selected pages. Detect matches 1112 produces candidate records. Compute replacement values 1114 computes replacement encodings. Verify authenticated payload 1116 checks whether patch authorization is satisfied if required. Suspend threads and change permissions 1118 establishes a safe write posture. Write replacement bytes 1120 applies the replacement. Restore permissions and flush cache 1122 reestablishes a proper execution posture. Log patch record 1124 records the patch event. Resume execution 1126 returns the process to run state. Optional rollback/end 1128 ends the run or restores prior state.

The sequence of FIG. 11 is representative. In one embodiment, generate encoded patterns 1108 occurs before attach or preload 1104 if the injector is preconfigured with a target application and a selected scheme. In another embodiment, verify authenticated payload 1116 occurs before compute replacement values 1114 where the policy requires authentication before correction-specific arithmetic. In another embodiment, log patch record 1124 includes both a precommit log and a postcommit log. In another embodiment, optional rollback/end 1128 includes a branch to comparative-output engine 1012. In another embodiment, detect matches 1112 may occur even if patch authorization is not present, but write replacement bytes 1120 is disabled. In another embodiment, compute replacement values 1114 may be deferred until after detect matches 1112 so that replacements are only generated for actual candidates found. These variations are within the present disclosure because the key machine operations are disclosed and their permissible orderings are understood to be implementation-and policy-dependent unless a claim expressly requires a stricter sequence.

The method also supports explicit failure pathways. If identify target executable 1102 fails, the method may end with a machine-readable error state. If enumerate executable pages 1106 yields no eligible pages, the method may end as a no-targets-found condition. If detect matches 1112 yields candidates but verify authenticated payload 1116 fails under a mandatory-authentication policy, the method may terminate as detect-only or refused. If suspend threads and change permissions 1118 fails for a direct-write path, the method may attempt a shadow-page fallback where permitted. If write replacement bytes 1120 succeeds but restore permissions and flush cache 1122 fails, rollback may be invoked before resume execution 1126. In another embodiment, if logging at 1124 fails under a policy requiring durable rollback state, optional rollback/end 1128 is entered automatically and the patched state is not left active. The present disclosure therefore supports not only the happy path but also concrete exception-handling logic.

FIG. 12 illustrates an exemplary executable page region 1200. Pre-patch constant instance 1202 is the original encoded target value. Matched byte sequence 1204 is the byte pattern identified as corresponding to a selected target. Offset location 1206 is the address or offset of the match. Replacement byte sequence 1208 is the encoded replacement written in place of the original or written into a shadow page. Post-patch constant instance 1210 is the resulting machine-level value. Occurrence one 1212, occurrence two 1214, and occurrence three 1216 illustrate multiple occurrences in the same region or page. Page-state transition 1218 indicates the relevant page or mapping state change associated with patching. Tolerance window 1220 indicates the permitted detection band, such as the preferred plus/minus one ULP. Checksum value 1222 indicates an integrity value associated with the patch event. Patch status 1224 records the state of the location.

FIG. 12 makes the binary-level nature of the invention especially clear. The disclosed injector does not require that the source code identify a symbolic constant name at the moment of patching. Instead, the machine-represented matched byte sequence 1204 at offset location 1206 is compared against encoded patterns, and replacement byte sequence 1208 is written when policy and verification permit. In one embodiment, all occurrences 1212, 1214, and 1216 are patched. In another embodiment, only occurrences belonging to a selected module scope are patched. In another embodiment, checksum value 1222 is stored per occurrence. In another embodiment, page-state transition 1218 reflects not only permission change but also remap to shadow page 512. In another embodiment, patch status 1224 may distinguish detected, grouped, authorized, patched, verified, restored, stale, refused, excluded, or comparative-only states. The flexibility of patch status 1224 is useful because it gives the system a precise machine vocabulary for operational state. In some embodiments, patch status 1224 is also stored in candidate location list 216 or patch log store 612 so that the state of each occurrence is machine-queryable after the run.

Additional implementation detail is now provided regarding target-value selection and classification. In one embodiment, target-value set 300 is limited to a fixed set of disclosed physical constants and their integer powers from one through thirty-two. In another embodiment, target-value set 300 includes at least one direct constant entry 302 and at least one derived constant entry 304. In another embodiment, target-value set 300 supports a configuration where one direct constant entry 302 is patch-enabled, another is detect-only, and a derived constant entry 304 is excluded unless a stricter policy is satisfied. In another embodiment, target-value set 300 is versioned so that a future run can reproduce the same scan and patch behavior. In another embodiment, target-value set 300 stores grouping rules indicating whether a target class must be patched consistently across all detected occurrences, all occurrences in a module, or all occurrences in a transaction. In another embodiment, target-value set 300 stores expected occurrence counts or occurrence ranges that can be checked during match evaluation, and mismatch between an observed occurrence count and an expected occurrence count can cause refusal, detect-only reclassification, or audit tagging under the active policy. Such details are useful because later claims may need support for selectors, classifiers, group policies, and machine-enforced consistency rules.

Additional implementation detail is also provided regarding duplicate occurrences and consistency management. In many practical compiled executables, the same target value or power may appear at multiple offsets due to compiler optimizations, inlining, constant propagation, repeated literal use, or duplicated module-level definitions. In one embodiment, candidate location list 216 is normalized after detection so that duplicate logical target classes are tracked as grouped occurrences. As used herein, a grouped occurrence set means a set of two or more candidate locations grouped by target-value identifier and, where applicable, power identifier, and optionally further grouped by module identity or page identity. In another embodiment, a target-value identifier field 420 plus power identifier field 422 combination defines a logical patch group. In another embodiment, a patch group is expanded further to include module identity or page identity. In an all-occurrence policy, patch controller 500 refuses to patch if any member of the group cannot be safely patched. In a partial-occurrence policy, patch controller 500 patches only the eligible members but records that decision explicitly in patch completion output 522 and audit module 118. In a detect-only policy, grouping still occurs so that the operator can see complete logical occurrence sets even though no write occurs. This level of detail is included because it provides clear support against criticisms that the invention is merely “find one matching literal and change it.”

In some embodiments, grouped occurrence handling is governed by ordered machine rules rather than ad hoc operator judgment. By way of example, a grouped occurrence set may be activated only after all presently visible members of the set have been normalized into deterministic order, verified to fall within an allowed module scope, checked against any configured expected occurrence count, and confirmed not to include a stale member whose live bytes no longer correspond to the previously detected prepatch value. If any such condition fails, the grouped occurrence set may be retained for detect-only reporting, marked as refused, rescanned, or escalated under the active policy without partially committing a patch that would leave related compiled occurrences in an inconsistent state.

Additional implementation detail is further provided regarding stale-candidate handling. A candidate identified through scratch buffer 212 may become stale before patch time because live memory changes after scanning. In one embodiment, patch controller 500 rechecks the current live bytes at offset location 1206 before writing replacement byte sequence 1208. If the live bytes differ from the expected original representation or differ beyond tolerance window 1220, patch status 1224 can be set to stale and patching of that location can be refused. In another embodiment, stale candidates trigger rescanning of the associated page. In another embodiment, if any stale candidate belongs to a consistency-required group, the whole group is refused or rescanned. In another embodiment, stale candidates are logged to audit archive 724 for postrun review. In another embodiment, stale candidates are retained in candidate location list 216 with a stale classification so that the system can distinguish “not found” from “found but changed before patch.” This stale-candidate logic is a concrete mechanism addressing the fact that scanning and patching need not happen at exactly the same instant.

Additional implementation detail is also provided regarding deterministic ordering and transaction control. In a preferred embodiment, candidate records 416 are sorted by module, page, and offset before patching. In another embodiment, a transaction ID is assigned to each patch group before write operations begin. In another embodiment, checkpoint record 524 is updated after each write so that a partially completed transaction can be rolled back if a later write fails. In another embodiment, log patch record 1124 records both the transaction scope and per-location scope. In another embodiment, reproducibility record 1024 stores transaction ordering data. In another embodiment, patch completion output 522 includes the transaction identifier of the committed transaction. Such deterministic ordering is useful because two runs using the same binary, same target-value set, same payload, and same policy can thereby produce the same patch order and the same final patch record set, thereby strengthening reproducibility and auditability.

Additional implementation detail is also provided regarding authorization and policy gating. Verification result 714 can be positive while deployment policy 1018 still refuses patching because the payload is valid but not approved for the selected deployment scope. Conversely, deployment policy 1018 may allow detect-only scanning even when verification result 714 is absent or negative. In one embodiment, configuration input 122 selects a fail-closed mode in which any authorization uncertainty blocks write operations. As used herein, authorization uncertainty means a machine-detectable state in which a write-enabling authorization condition cannot be affirmatively verified at runtime, including missing verification key material, an invalid or absent payload signature, a mismatched payload digest, an expired authorization window, or a failed scope validation for a candidate location. In another embodiment, configuration input 122 selects a local testing mode in which writes are permitted from a locally trusted payload without external ledger publication. In another embodiment, configuration input 122 selects an audit-only mode in which signed audit record 718 is produced even though patch engine 110 remains inactive. In another embodiment, deployment policy 1018 uses separate controls for cryptographic validity, operational approval, and publication approval. This explicit distinction between authenticity and policy acceptance is useful both operationally and for later claim support.

Additional implementation detail is further provided regarding failure handling. If permission change module 504 cannot obtain writable page state 506, patch controller 500 may query deployment policy 1018 to determine whether shadow page generator 510 may be used. If shadow page generator 510 succeeds but remap module 514 fails, the transaction may be aborted and no successful patch completion output 522 is emitted. If instruction cache flush module 516 reports failure, thread resume module 520 may be delayed pending rollback or administrative intervention. If integrity logger 600 cannot persist patch record 602 under a policy requiring durable rollback records, the system may immediately invoke restore engine 616 rather than continue in a patched but unrecorded state. If audit archive 724 is unavailable, the policy may still permit local patching or may refuse patching depending on the selected mode. In another embodiment, if output/verification interface 124 cannot emit a required machine-readable success signal, the system may hold the patched state in a provisional condition pending remediation. The disclosure of these objective failure rules is important because it demonstrates practical implementation readiness and supports narrower dependent claims on fallback behavior.

Additional implementation detail is also provided regarding detect-only, audit-only, and comparative operation. In a detect-only mode, page scanner 400, comparison engine 408, ULP tolerance evaluator 410, and match detector 412 operate normally and produce detection list 414, but write replacement bytes 1120 does not occur. In an audit-only mode, detection and policy evaluation occur, and signed audit record 718 may be created, but patch engine 110 remains disabled. In a comparative mode, a first run may produce patched output set 1014 and a second run, after rollback or without patching, may produce unpatched output set 1016, with comparative-output engine 1012 organizing the results. In another comparative mode, multiple patch payloads 702 corresponding to different correction schemes are evaluated in separate runs. In yet another comparative mode, one scheme may be patch-enabled while another scheme is used only to generate a hypothetical comparison report. These modes demonstrate that the architecture supports experimentation, validation, and staged rollout rather than only one-way modification.

Additional implementation detail is also provided regarding local, remote, and distributed embodiments. In a local embodiment, constant-pattern library 106, correction engine 108, patch engine 110, security control module 112, integrity/rollback store 114, authentication module 116, audit module 118, loader interface 120, configuration input 122, and output/verification interface 124 all reside on the same host as target physics application 910. In a remote-assisted embodiment, network interface 914 may retrieve patch payload 702, keys for public key store 712, or policy bundles while scanning and patching remain local. In a cluster embodiment, job scheduler 918 may coordinate consistent policy injection across multiple cluster nodes 920, while each node performs local scanning and patching against its own target physics application 910 instance. In a containerized embodiment, container runtime 916 hosts the target application while injector binary 912 is introduced at launch or through another deployment mechanism. In another embodiment, reproducibility record 1024 is collected from multiple cluster nodes 920 into a centralized audit process. These variants are disclosed to support broad but concrete claim coverage.

Additional implementation detail is also provided regarding current-use records versus historical records. Patch log store 612 and audit archive 724 may store historical records from completed runs. Those records do not themselves define the currently active patch state unless they are loaded into an active control path. Current-use records are those controlling the present execution, such as the active patch payload 702, active target-value set 300, active deployment policy 1018, or active checkpoint record 524. Historical records are useful for reproduction, proof, and review. Current-use records are useful for control. The disclosure intentionally distinguishes these categories because later claim drafting may rely on the difference between a stored archive and an active machine-control input. In some embodiments, a historical record may be promoted into a current-use input only through a policy-governed activation step.

Additional implementation detail is also provided regarding machine-actionable outputs versus human-readable outputs. Output/verification interface 124 may emit structured status objects, event streams, counts, identifiers, verification booleans, or control signals, including excluded-by-scope classifications, stale-candidate classifications, awaiting-authorization classifications, verification-required classifications, and count-mismatch classifications. These are machine-actionable outputs. Audit module 118 may also generate rendered summaries or logs for human review. Those are human-readable outputs. Human-readable outputs can be derived from machine-actionable state but do not necessarily control the patch process themselves. This distinction is especially useful where later claims may seek to emphasize machine control rather than mere reporting. In some embodiments, deployment result 1022 is a machine-readable code even if also displayed in textual form to a user.

In some embodiments, the disclosed outputs are not limited to presentation of patch information for human review, but are consumed by downstream machine logic that determines whether a patch transaction is allowed to commit, whether execution may resume, whether rollback must be invoked, whether a comparative run should proceed under a patched or unpatched regime, whether a grouped occurrence set satisfies an expected-count rule, or whether a run should be classified as patch-enabled, detect-only, audit-only, rollback-complete, or refused. The disclosed output architecture therefore forms part of a concrete machine-control workflow for executable-state management rather than merely constituting post-solution display of information.

Additional implementation detail is also provided regarding optional formal assurance and implementation artifacts. In some embodiments, one or more properties of the replacement arithmetic, patch size, deterministic behavior, signature handling, or rollback symmetry are machine-verified or formally checked. In other embodiments, the injector is practiced without such a layer. Likewise, some embodiments use optimized scan implementations, including vectorized or SIMD-assisted comparison paths, while others use scalar paths. Some embodiments use specific named cryptographic or checksum primitives as disclosed. Other embodiments may employ alternative implementations only to the extent supported by the claims ultimately presented and prosecution history. The present disclosure includes these examples to provide concrete implementation substance without importing every implementation preference into every claim. In no event should the presence of a formal verification artifact be read as required for ordinary operation unless a claim expressly so states.

Additional implementation detail is also provided regarding Recognition-Physics-specific operation. In the preferred embodiment, X_opt generator 314 produces an optimal recognition scale, R_RP store 316 provides a loop correction ratio, and delta_loop generator 318 computes a loop correction parameter from those values. Correction factor store 320 then stores one minus that parameter or a directly usable equivalent. Replacement value generator 322 applies that factor to each selected target class, and where power index 306 is present, computes the corresponding power-consistent replacement. This preferred embodiment is especially useful because it provides a practical runtime adoption mechanism for numerically corrected constants in legacy compiled software. The injector therefore acts as an adoption bridge between a selected correction theory and a large installed base of compiled applications that cannot easily be rebuilt. That adoption-bridge function is a concrete technical effect of the architecture. The injector is useful even where the downstream executable is closed-source, validated, containerized, or part of a large-scale simulation environment.

Additional implementation detail is also provided regarding optional selective scope control. In one embodiment, configuration input 122 selects only one target-value identifier field 420 for patching. In another embodiment, both target-value identifier field 420 and power identifier field 422 are used to define a patch scope, such as only first-order occurrences or only a selected power range within the disclosed range. In another embodiment, a module selector associated with configuration input 122 limits patching to one module while leaving others detect-only. In another embodiment, deployment policy 1018 imposes a patch-count ceiling or requires exact occurrence counts before patching is allowed. As used herein, a configured maximum count means a configured maximum count for a page, a module, or a run, where exceeding the configured maximum count causes refusal or reclassification under a detect-only mode according to the active policy. In another embodiment, one target-value class is patch-enabled while another is marked report-only. These selection and ceiling rules are useful because they provide concrete, objective criteria for narrowing and controlling operation.

Additional implementation detail is also provided regarding run reproducibility. In one embodiment, reproducibility record 1024 includes the version of target-value set 300, the version or identity of patch payload 702, the selected loader path from loader framework 800, the candidate count, the committed patch count, the transaction order, the target module scope, the authorization outcome, and the timestamps associated with patching and rollback. In another embodiment, reproducibility record 1024 includes the digest of patch payload 702, the digest of signed audit record 718, and the configured maximum count in effect for the run. In another embodiment, reproducibility record 1024 is stored locally and also exported through Ecoh-Ledger interface 722. In another embodiment, reproducibility record 1024 includes detect-only findings so that a no-patch run can still be reproduced analytically. These details matter because the system is intended for scientifically and operationally meaningful use, where it is often necessary to know not just what the target application output was, but under which exact numerical and policy regime the output was generated.

Additional implementation detail is also provided regarding the practical distinction between semantic modifications and presentation-only modifications. When replacement byte sequence 1208 replaces matched byte sequence 1204, the machine-operational semantics of target executable process 102 may change because the process now consumes a different numerical value. By contrast, a report that merely states what a replacement would have been, without writing the bytes, is only a presentation of a hypothetical condition and does not itself alter execution semantics. The system supports both categories deliberately, and the present description keeps them distinct so that claims can later emphasize machine-state control where appropriate. Likewise, storing a historical patch record is not the same as activating that patch record for current use.

Additional implementation detail is also provided regarding observation versus action. Detection list 414 and candidate records 416 represent observation and classification. Patch controller 500, direct write module 508, shadow page generator 510, remap module 514, and restore engine 616 represent machine action. In some modes, the observation path operates while the action path remains inactive. In other modes, both are active. In still other modes, the action path becomes active only after the observation path, the authorization path, and the policy path all succeed. This layered path structure is a recurring design principle of the invention and is useful for reducing unintended modifications, improving auditability, and supporting flexible deployment policies.

The architecture described with respect to FIGS. 1-12 therefore provides a comprehensive, concrete, and robust framework for dynamic binary instrumentation of selected numerical values in compiled physics software. It supports target selection, page selection, page scanning, candidate classification, objective tolerance-based detection, power-aware replacement generation, policy-aware authorization, safe overwrite execution, direct-write and shadow-page alternatives, deterministic transaction handling, rollback, audit, local and distributed deployment, container and scheduler compatibility, detect-only and comparative modes, and machine-readable reproducibility. These elements interact to create a runtime instrumentation platform that is materially different from generic source editing, generic tracing, generic hooking, or uncontrolled memory editing. The result is a machine-implementable system for updating already compiled software at the level where the software actually consumes selected numerical values.

It will be understood that the foregoing description is illustrative rather than limiting. Features disclosed in connection with one embodiment may be combined with features disclosed in connection with another embodiment unless technically incompatible. Optional features are not required unless expressly recited in a claim. No particular operating system version, benchmark figure, cryptographic primitive, checksum primitive, page size, vector instruction set, programming language, or formal verification environment is required unless expressly recited in a claim. No numeral, figure arrangement, ordering detail, or implementation preference should be imported into a claim unless that claim expressly requires it. The scope of the invention is therefore defined by the claims as filed and as properly amended, rather than by any single example, preference, or deployment scenario described above.

1. A computer-implemented method for modifying machine-encoded numerical values in compiled physics software, the method comprising: identifying a target executable process executing on a host computing system; enumerating, by the host computing system, executable memory pages of the target executable process; selecting, from the executable memory pages, one or more scan-selected pages for analysis; copying each scan-selected page into a scratch buffer; generating, for each of a plurality of target values, a corresponding machine-encoded reference pattern, wherein the plurality of target values comprises at least one physical constant or at least one integer power from one through thirty-two of a physical constant; scanning the scratch buffer in aligned 8-byte chunks interpreted as IEEE-754 double-precision values to identify one or more candidate locations containing machine-encoded values matching one or more of the machine-encoded reference patterns when a candidate value is within plus or minus one unit in the last place of a selected machine-encoded reference pattern; computing, for at least one candidate location, a replacement value according to a selected correction scheme; encoding the replacement value into a machine-encoded replacement pattern; confirming, before writing, that the at least one candidate location falls within an allowed module scope under an active policy; changing a memory-permission state associated with a target page containing the at least one candidate location to permit writing of the machine-encoded replacement pattern; writing the machine-encoded replacement pattern to the at least one candidate location; verifying, after writing and before success is indicated, that bytes currently present at the at least one candidate location correspond to the machine-encoded replacement pattern; restoring the memory-permission state associated with the target page after writing the machine-encoded replacement pattern; recording, in a rollback record, original bytes and replacement bytes associated with the at least one candidate location; withholding resumption until the rollback record has been stored; and resuming execution of the target executable process with the machine-encoded replacement pattern active at the at least one candidate location.

2. The method of claim 1, wherein scanning the scratch buffer comprises traversing the scratch buffer in aligned 8-byte chunks, interpreting the aligned 8-byte chunks as IEEE-754 double-precision values, and excluding misaligned candidate values from patch-eligible classification.

3. The method of claim 2, wherein the objective comparison criterion comprises determining whether a candidate machine-encoded value is within plus or minus one unit in the last place of a selected machine-encoded reference pattern.

4. The method of claim 1, wherein the plurality of target values comprises a direct physical constant and a plurality of integer powers from one through thirty-two of the direct physical constant.

5. The method of claim 4, wherein computing the replacement value comprises computing a corrected constant C′ from a constant C and computing, for a detected power n, a replacement equal to (C′)\hat{ }n while preserving multiplicative consistency across grouped occurrences associated with the constant C.

6. The method of claim 1, further comprising, before writing the machine-encoded replacement pattern, revalidating that bytes currently present at the at least one candidate location still correspond to an expected prepatch value, and refusing the writing when the bytes currently present do not correspond to the expected prepatch value or when a required grouped occurrence set, grouped by target-value identifier and power identifier and, where applicable, module identity, includes a stale member.

7. The method of claim 1, wherein changing the memory-permission state and writing the machine-encoded replacement pattern comprise suspending one or more threads of the target executable process before writing and resuming the one or more threads after restoring the memory-permission state, and wherein the method further comprises refusing a patch transaction when a required grouped occurrence set, grouped by target-value identifier and power identifier and, where applicable, module identity, is not fully patchable, when a current patch count exceeds a configured maximum count for a page, a module, or a run, or when an observed occurrence count mismatches an expected occurrence count for the grouped occurrence set where such expected occurrence count is provided.

8. The method of claim 1, further comprising flushing or invalidating instruction-cache state associated with the target page after writing the machine-encoded replacement pattern and before resuming execution of the target executable process, withholding patch completion until the rollback record has been stored, withholding resumption of any suspended thread until the rollback record has been stored, and withholding a success indication until postwrite verification completes when patching is performed.

9. The method of claim 1, wherein recording the rollback record further comprises generating a CRC-32 checksum associated with the original bytes and the replacement bytes, storing a transaction identifier associated with a patch group, storing a module identity associated with the patch group, storing a page identity associated with the patch group, storing a run identifier associated with the patch group, and storing a path type indicating whether patching proceeded by direct write or shadow-page remap.

10. The method of claim 1, further comprising, after recording the rollback record, verifying that bytes currently present at the at least one candidate location correspond to the machine-encoded replacement pattern, restoring the original bytes from the rollback record in response to a rollback command or unload event, verifying successful restoration after restoring the original bytes, refusing partial restoration when a policy requires transaction-integrity restoration, and retaining a refusal classification when transaction-integrity restoration is not achieved.

11. The method of claim 1, further comprising receiving a patch payload and verifying, before writing the machine-encoded replacement pattern, that the patch payload is authenticated under an active authorization policy, that the at least one candidate location falls within an allowed module scope, and that a detect-only classification is retained instead of patching when write authorization is not satisfied.

12. The method of claim 11, wherein verifying that the patch payload is authenticated comprises computing a digest of the patch payload, verifying a digital signature associated with the patch payload using a verification key, and enabling writing of the machine-encoded replacement pattern only when the digital signature is valid under the active authorization policy and a write-enabling authorization condition is affirmatively verified at runtime.

13. The method of claim 1, wherein the selected correction scheme is a Recognition-Physics correction scheme in which a loop correction parameter is derived from an optimal recognition scale and a loop correction ratio, and the replacement value is based on one minus the loop correction parameter.

14. A dynamic binary instrumentation system for modifying machine-encoded numerical values in compiled physics software, the system comprising: a loader interface configured to obtain operative access to a target executable process; a constant-pattern library configured to store or generate machine-encoded reference patterns corresponding to a plurality of target values comprising at least one physical constant or at least one integer power from one through thirty-two of a physical constant; a page-scanning subsystem configured to identify executable memory pages of the target executable process, copy a selected executable memory page into a scratch buffer, interpret aligned 8-byte chunks in the scratch buffer as IEEE-754 double-precision values, and detect one or more candidate locations in the scratch buffer by determining whether a candidate value is within plus or minus one unit in the last place of a selected one of the machine-encoded reference patterns; a correction engine configured to compute a replacement value for at least one detected candidate location according to a selected correction scheme; a patch engine configured to encode the replacement value into a machine-encoded replacement pattern and, after optional revalidation that current bytes at the at least one detected candidate location still correspond to an expected prepatch value and that the at least one detected candidate location falls within an allowed module scope under an active policy, write the machine-encoded replacement pattern to memory associated with the target executable process, and to verify, after writing and before reporting success, that current bytes at the at least one detected candidate location correspond to the machine-encoded replacement pattern; a security control module configured to control at least one of thread coordination, memory-permission changes, cache-state handling associated with writing the machine-encoded replacement pattern, withholding continued execution until rollback-record storage is confirmed, or withholding success reporting until postwrite verification succeeds; an integrity and rollback store configured to record original bytes and replacement bytes associated with the at least one detected candidate location; and an output interface configured to emit a machine-readable status indicating at least one of detection, detect-only state, audit-only state, patch completion, rollback state, direct-write completion, shadow-path completion, awaiting-authorization state, verification-required state, count-mismatch state, excluded-by-scope state, stale-candidate state, or refusal state.

15. The system of claim 14, wherein the page-scanning subsystem is configured to normalize the one or more candidate locations into a deterministic address order before patching, to group candidate locations according to target-value identifier and, where applicable, according to power identifier and according to module identity before patching, to evaluate grouped candidate locations against expected occurrence counts where provided, to prevent patch commitment for a group when an observed occurrence count mismatches an expected occurrence count for that group, and to retain grouped candidate records, stale-candidate classifications, excluded-by-scope classifications, awaiting-authorization classifications, verification-required classifications, and count-mismatch classifications for detect-only reporting when patching is not performed.

16. The system of claim 14, wherein the security control module is configured to place a target page into a writable state before the patch engine writes the machine-encoded replacement pattern, to restore a prior memory-permission state after the patch engine writes the machine-encoded replacement pattern, and, where applicable, to flush or invalidate instruction-cache state before continued execution, to refuse patching when current bytes at a candidate location fail revalidation against an expected prepatch value, to withhold continued execution until rollback-record storage is confirmed, and to withhold direct-write completion until postwrite verification succeeds when a direct-write path is used.

17. The system of claim 14, wherein the patch engine is further configured to generate a shadow copy of a target page, apply the machine-encoded replacement pattern to the shadow copy, verify that the shadow copy contains the machine-encoded replacement pattern at an expected target location, redirect execution to the shadow copy, verify successful remap before reporting shadow-path completion, verify that rollback-record storage is confirmed before reporting shadow-path completion, refuse shadow-path completion when remap fails, and emit a machine-readable status identifying shadow-path refusal.

18. The system of claim 14, further comprising an authentication module configured to compute a digest of a patch payload, verify a digital signature associated with the patch payload using a verification key, and permit the patch engine to write the machine-encoded replacement pattern only when the digital signature is valid under an active authorization policy, the at least one detected candidate location falls within an allowed module scope, a write-enabling authorization condition is affirmatively verified at runtime, and a detect-only classification is retained when write authorization is not satisfied.

19. A non-transitory computer-readable medium storing instructions that, when executed by one or more processors, cause the one or more processors to perform operations comprising: identifying a target executable process; enumerating executable memory pages of the target executable process; copying at least one selected executable memory page into a scratch buffer; detecting at least one candidate location in the scratch buffer by scanning aligned 8-byte chunks of the scratch buffer interpreted as IEEE-754 double-precision values and determining that a candidate value is within plus or minus one unit in the last place of a selected machine-encoded reference pattern corresponding to at least one physical constant or at least one integer power from one through thirty-two of a physical constant; computing a replacement value for the at least one candidate location according to a selected correction scheme; encoding the replacement value into a machine-encoded replacement pattern; confirming, before writing, that the at least one candidate location falls within an allowed module scope under an active policy; writing the machine-encoded replacement pattern to memory associated with the target executable process under controlled memory-permission conditions that include changing a memory-permission state to permit writing, restoring the memory-permission state after writing, and, where applicable, flushing or invalidating instruction-cache state before continued execution; verifying, after writing and before continued execution, that current bytes at the at least one candidate location correspond to the machine-encoded replacement pattern; recording original bytes and replacement bytes associated with the at least one candidate location to support subsequent rollback; and withholding continued execution until the original bytes and the replacement bytes have been recorded.

20. The non-transitory computer-readable medium of claim 19, wherein the operations further comprise computing a digest of a patch payload, verifying a digital signature associated with the patch payload using a verification key before writing the machine-encoded replacement pattern, revalidating that bytes currently present at the at least one candidate location still correspond to an expected prepatch value before writing the machine-encoded replacement pattern, refusing a patch transaction when a required grouped occurrence set, grouped by target-value identifier and power identifier and, where applicable, module identity, is not fully patchable, when a current patch count exceeds a configured maximum count for a page, a module, or a run, or when an observed occurrence count mismatches an expected occurrence count for the grouped occurrence set where such expected occurrence count is provided, storing a transaction identifier associated with a patch group, storing a CRC-32 checksum associated with the original bytes and the replacement bytes, storing a module identity associated with the patch group, storing a page identity associated with the patch group, storing a run identifier associated with the patch group, verifying that the at least one candidate location falls within an allowed module scope, restoring the original bytes in response to a rollback command or unload event, verifying successful restoration after restoring the original bytes, refusing partial restoration when a policy requires transaction-integrity restoration, retaining a refusal classification when transaction-integrity restoration is not achieved, withholding a success state until restoration verification completes when restoration is invoked, withholding a success state until rollback-record storage is confirmed, withholding a success state until postwrite verification completes when patching is performed, retaining grouped candidate records, stale-candidate classifications, excluded-by-scope classifications, awaiting-authorization classifications, verification-required classifications, and count-mismatch classifications for detect-only reporting when patching is not performed, and storing a path type indicating whether patching proceeded by direct write or shadow-page remap.
